(19) United States
(12) Patent Application Publication
(10) Pub. No.: US 2005/0271296 A1
(43) Pub. Date: Dec. 8, 2005

(54) Image processing apparatus, information processing apparatus, control method therefor, and program

(75) Inventors: Hiroyuki Tsuji, Yokohama-shi (JP); Yushi Matsukubo, Yokohama-shi (JP); Hiroyuki Yaguchi, Yokohama-shi (JP); Eiichi Nishikawa, Kawasaki-shi (JP); Shinichi Kato, Kawasaki-shi (JP); Masakazu Kitora, Kawasaki-shi (JP); Kenzou Sekiguchi, Machida-shi (JP); Hiroyoshi Yoshida, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/145,211

(22) Filed: Jun. 3, 2005

(30) Foreign Application Priority Data
Jun. 4, 2004 (JP) 2004-167672

(51) Int. Cl. G06K 9/40; G06K 9/36

(52) U.S. Cl. 382/275; 382/289

(57) ABSTRACT

Input image data is divided into a plurality of blocks. The skew angle of each divided block with respect to a predetermined direction is detected. Image data input from an input unit is converted into vector data for each divided block. The vector data corresponding to the divided block is corrected on the basis of the detected skew angle of each block.

### FIELD OF THE INVENTION

The present invention relates to an image processing apparatus, control method therefor, and program which perform an image process for input image data.

### BACKGROUND OF THE INVENTION

In recent years, amid calls for environmental issues, there has been a rapid progression toward paperless offices. As a technique for promoting paperless operation, there is proposed a document management system which reads paper documents stored in binders and the like with a scanner, converts the read images into image files in a portable document format (to be referred to as PDF hereinafter) or the like, and stores and manages the image files in an image storage.

A read image is generally compressed in a compression format such as JPEG, and the obtained compressed file is saved in a recording medium such as a hard disk.

In scan, the skew of image data can also be detected and corrected by rotating the image data by the skew angle (e.g., Japanese Patent Laid-Open Nos. 8-63548 and 4-98476). Skew correction is effective when, for example, a document is obliquely set and scanned on the document table of the scanner in scan or a document is fed with skew in scan using a document feeder (automatic document feeder).

In JPEG compression or the like, compressed/decompressed image data generally degrades its image more greatly as the compression ratio increases, unlike original image data. An image may degrade especially when a compressed image is decompressed once and then undergoes a rotation process in skew correction. Implementation of a rotation process at an arbitrary angle requires a large-scale circuit or long process time.

When a document prepared by cutting and laying out a plurality of articles is scanned, the skew angles of respective article image data contained in the scanned document image must be detected to rotate these image data in different directions.

When a plurality of image data are rotated and corrected in different directions, the image data may not be laid out as intended by the user, may overlap each other, or may protrude from the frame or document image.

Even image data whose skew is corrected to an erect state may be output as a skewed image on an output paper sheet owing to skew conveyance of the output paper sheet in printout. Such skew cannot be easily corrected.

### SUMMARY OF THE INVENTION

The present invention has been made to overcome the conventional drawbacks, and has as its object to provide an image processing apparatus, control method therefor, and program which can perform skew correction for an object in an image at high precision without any image degradation.

According to the present invention, the foregoing object is attained by providing an image processing apparatus which performs an image process for input image data, comprising:
input means for inputting image data;
division means for dividing the image data input from the input means into a plurality of blocks;
detection means for detecting a skew angle of each block divided by the division means;
convert means for converting the image data input from the input means into vector data for each block divided by the division means; and
correction means for correcting the vector data corresponding to the block on the basis of the skew angle of each block detected by the detection means.

In a preferred embodiment, the input means includes reading means for reading a document.

In a preferred embodiment, when a first block whose skew angle is corrected overlaps a second block, the correction means corrects the vector data corresponding to at least one of the first block and the second block.

In a preferred embodiment, the correction means enlarges or reduces the vector data corresponding to at least one of the first block and the second block.

In a preferred embodiment, the correction means changes a position of at least one of the first block and the second block.

In a preferred embodiment, the detection means detects a skew angle of a block of a predetermined attribute among the blocks divided by the division means, and
the correction means corrects the vector data corresponding to the block of the predetermined attribute on the basis of the skew angle detected by the detection means.

In a preferred embodiment, the apparatus further comprises inhibit means for inhibiting execution of correction by the correction means when the skew angle detected by the detection means is not smaller than a predetermined angle.

According to the present invention, the foregoing object is attained by providing an image processing apparatus which performs an image process for image data to be printed and outputs the image data to a printing unit, comprising:
first detection means for detecting a first skew angle, with respect to a convey direction, of a printing paper sheet conveyed along a printing paper convey path within the printing unit;
correction means for correcting vector data serving as the image data to be printed, on the basis of the first skew angle detected by the detection means; and
execution means for executing printing by the printing unit using the vector data corrected by the correction means.

In a preferred embodiment, the apparatus further comprises:
input means for inputting image data;
division means for dividing the image data input from the input means into a plurality of blocks;
second detection means for detecting a second skew angle of each block divided by the division means; and
convert means for converting the image data input from the input means into vector data for each block divided by the division means,
wherein the correction means corrects the vector data converted by the convert means, on the basis of the first skew angle and the second skew angle which are detected by the first detection means and the second detection means.

According to the present invention, the foregoing object is attained by providing a method of controlling an image processing apparatus which performs an image process for input image data, comprising:
an input step of inputting image data;
a division step of dividing the image data input in the input step into a plurality of blocks;
a detection step of detecting a skew angle of each block divided in the division step;
a convert step of converting the image data input in the input step into vector data for each block divided in the division step; and
a correction step of correcting the vector data corresponding to the block on the basis of the skew angle of each block detected in the detection step.

According to the present invention, the foregoing object is attained by providing a method of controlling an image processing apparatus which performs an image process for image data to be printed and outputs the image data to a printing unit, comprising:
a first detection step of detecting a first skew angle, with respect to a convey direction, of a printing paper sheet conveyed along a printing paper convey path within the printing unit;
a correction step of correcting vector data serving as the image data to be printed, on the basis of the first skew angle detected in the detection step; and
an execution step of executing printing by the printing unit using the vector data corrected in the correction step.

According to the present invention, the foregoing object is attained by providing a program for implementing control of an image processing apparatus which performs an image process for input image data, comprising:
a program code for an input step of inputting image data;
a program code for a division step of dividing the image data input in the input step into a plurality of blocks;
a program code for a detection step of detecting a skew angle of each block divided in the division step;
a program code for a convert step of converting the image data input in the input step into vector data for each block divided in the division step; and
a program code for a correction step of correcting the vector data corresponding to the block on the basis of the skew angle of each block detected in the detection step.

According to the present invention, the foregoing object is attained by providing a program for implementing control of an image processing apparatus which performs an image process for image data to be printed and outputs the image data to a printing unit, comprising:
a program code for a first detection step of detecting a first skew angle, with respect to a convey direction, of a printing paper sheet conveyed along a printing paper convey path within the printing unit;
a program code for a correction step of correcting vector data serving as the image data to be printed, on the basis of the first skew angle detected in the detection step; and
a program code for an execution step of executing printing by the printing unit using the vector data corrected in the correction step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing the arrangement of an image processing system according to the first embodiment of the present invention;

FIG. 2 is a block diagram showing the detailed arrangement of an MFP according to the first embodiment of the present invention;

FIG. 3 is a flowchart showing the outline of an overall process executed by the image processing system according to the first embodiment of the present invention;

FIG. 4A is a view showing an example of an operation window according to the first embodiment of the present invention;

FIG. 4B is a view showing an example of an operation window according to the first embodiment of the present invention;

FIG. 4C is a view showing an example of an operation window according to the first embodiment of the present invention;

FIG. 5A is a view for explaining the concept of a block selection process according to the first embodiment of the present invention;

FIG. 5B is a view for explaining the concept of the block selection process according to the first embodiment of the present invention;

FIG. 6A is a view showing an example of block information according to the first embodiment of the present invention;

FIG. 6B is a view for explaining a skew angle detection process according to the first embodiment of the present invention;

FIG. 7 is a view for explaining a vectorized process according to the first embodiment of the present invention;

FIG. 8 is a view for explaining the vectorized process according to the first embodiment of the present invention;

FIG. 9 is a flowchart showing a vector data grouping process according to the first embodiment of the present invention;

FIG. 10 is a flowchart showing details of a process in step S701 according to the first embodiment of the present invention;

FIG. 11 is a view showing the data structure of a DAOF according to the first embodiment of the present invention;

FIG. 12 is a flowchart showing details of an apli (application) data convert process according to the first embodiment of the present invention;

FIG. 13 is a flowchart showing details of a process in step S8002 according to the first embodiment of the present invention;

FIG. 14A is an explanatory view showing a document structure tree according to the first embodiment of the present invention;

FIG. 14B is an explanatory view showing the document structure tree according to the first embodiment of the present invention;

FIG. 15A is a view for explaining a skew correction process according to the first embodiment of the present invention;

FIG. 15B is a view for explaining the skew correction process according to the first embodiment of the present invention;

FIG. 15C is a view for explaining the skew correction process according to the first embodiment of the present invention;

FIG. 16 is a view showing an example of an operation window according to the second embodiment of the present invention;

FIG. 17 is a view showing an example of an operation window according to the second embodiment of the present invention;

FIG. 18A is a view showing an example of an operation window according to the second embodiment of the present invention;

FIG. 18B is a view showing an example of an operation window according to the second embodiment of the present invention;

FIG. 18C is a view showing an example of an operation window according to the second embodiment of the present invention;

FIG. 19A is a view showing an example of an operation window according to the second embodiment of the present invention;

FIG. 19B is a view showing an example of an operation window according to the second embodiment of the present invention;

FIG. 19C is a view showing an example of an operation window according to the second embodiment of the present invention;

FIG. 19D is a view showing an example of an operation window according to the second embodiment of the present invention;

FIG. 20 is a sectional view showing an example of the arrangement of a printing unit according to the fourth embodiment of the present invention;

FIG. 21 is a view for explaining a detection principle of detecting the skew state (skew) of a printing paper sheet according to the fourth embodiment of the present invention; and

FIG. 22 is a flowchart showing a printing process according to the fourth embodiment of the present invention.

### DETAILED DESCRIPTION OF THE PREFERRED EMBODIMENTS

Preferred embodiments of the present invention will be described in detail in accordance with the accompanying drawings.

### First Embodiment

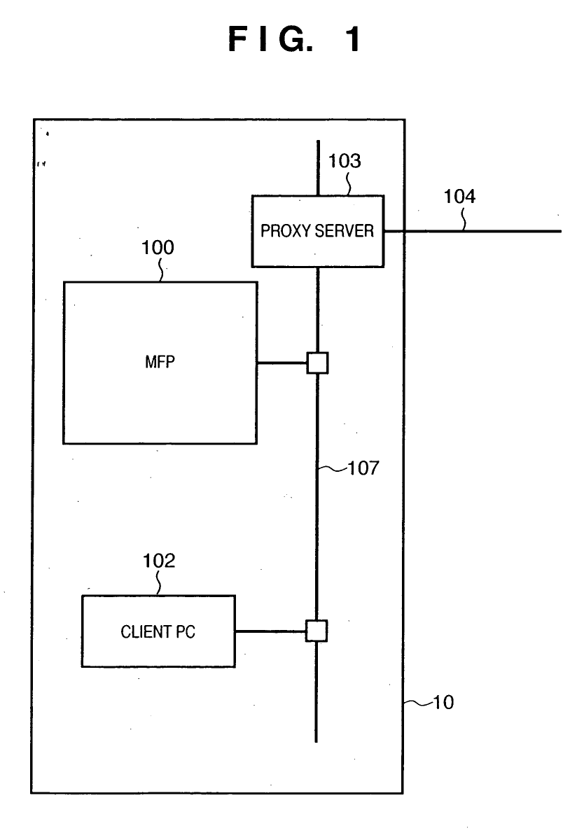

FIG. 1 is a block diagram showing the arrangement of an image processing system according to the first embodiment of the present invention.

In FIG. 1, a LAN 107 constructed in an office 10 is connected to an MFP (Multi Function Peripheral) 100 which realizes a plurality of types of functions (copying function, printing function, transmission (file transmission and FAX transmission) function, and the like), and a client PC 102 and a proxy server 103 which receive transmission data from the MFP 100 and utilize functions realized by the MFP 100. The LAN 107 is connected to a network 104 via the proxy server 103.

For example, by transmitting printing data to the MFP 100, the client PC 102 can cause the MFP 100 to print a material based on the printing data.

The arrangement of FIG. 1 is merely an example, and a plurality of offices having the same building components as those in the office 10 may be connected to the network 104.

The network 104 is a so-called communication network which is typically realized by one or a combination of the Internet, LAN, WAN, telephone line, dedicated digital circuit, ATM, frame relay line, communication satellite channel, cable television line, data broadcasting radio channel, and the like as far as the network enables data exchange.

Various terminals of the client PC 102 and proxy server 103 each have standard building components (e.g., CPU, RAM, ROM, hard disk, external storage, network interface, display, keyboard, and mouse) which are mounted in a general-purpose computer.

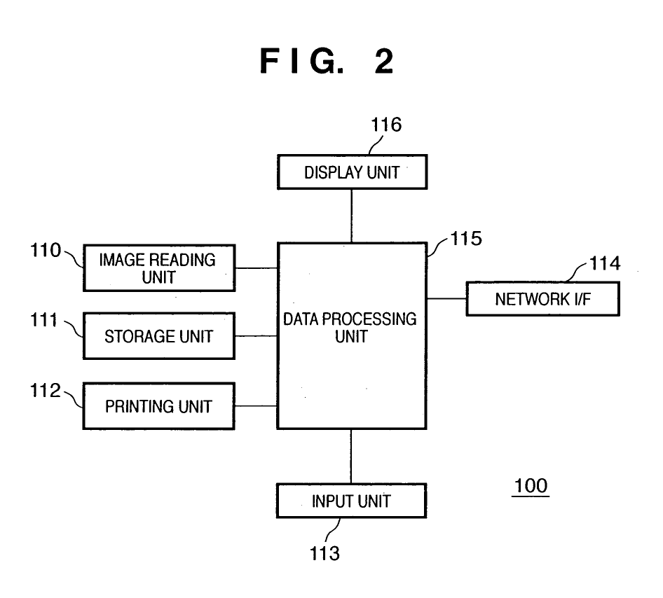

The detailed arrangement of the MFP 100 will be explained with reference to FIG. 2.

FIG. 2 is a block diagram showing the detailed arrangement of the MFP according to the first embodiment of the present invention.

In FIG. 2, an image reading unit 110 is made up of, e.g., a scanner and reader. Particularly when the image reading unit 110 is formed from a scanner and reader, it further comprises an auto document feeder (ADF). The image reading unit 110 irradiates a bundle or one of document images with a light source (not shown), forms a reflected document image on a solid-state image sensing element via a lens, and obtains raster-scanned image data from the solid-state image sensing element as a raster image at a predetermined density (600 dpi or the like).

The image reading unit 110 can be implemented by any device other than the scanner and reader, such as an image sensing apparatus (e.g., a digital camera or digital video apparatus), an information processing apparatus having a CPU (e.g., a PC or PDA), or a communication apparatus (e.g., a mobile portable communication terminal or FAX apparatus) as far as the apparatus can input raster image data.

The main functions of the MFP 100 will be explained.

[Copying Function]

The MFP 100 has a copying function of printing an image corresponding to scanned image data on a printing medium by a printing unit 112. To form a copy of a document image, a data processing unit 115 (formed from a CPU, RAM, ROM, and the like) executes an image process including various correction processes for the scanned image data and generates printing data, and the printing unit 112 prints the printing data on a printing medium. To form copies of a document image, printing data of one page is temporarily stored and held in a storage unit 111, and sequentially output to the printing unit 112 to print the data on printing media.

Also, the data processing unit 115 can perform an image process including various correction processes for scanned image data and generate printing data, and the printing unit 112 can directly print the printing data on a printing medium without holding the printing data in the storage unit 111.

[Saving Function]

The MFP 100 saves scanned image data from the image reading unit 110 or scanned image data having undergone an image process in the storage unit 111.

[Transmitting Function]

With the transmitting function via a network I/F 114, scanned image data obtained by the image reading unit 110 or scanned image data saved in the storage unit 111 by the saving function is converted into an image file of a compressed image file format (e.g., TIFF or JPEG) or a vector data file format (e.g., PDF), and the image file is output from the network I/F 114. The output image file is transmitted to the client 102 via the LAN 107 or further transferred to an external terminal (e.g., another MFP or client PC) on a network via the network 104.

Although not shown, scanned image data can also be FAX-transmitted via a FAX I/F using a telephone line. Scanned image data can also be directly transmitted after undergoing various image processes associated with transmission by the data processing unit 115 without saving the data in the storage unit 111.

[Printing Function]

With the printing function of the printing unit 112, for example, printing data output from the client PC 102 is received by the data processing unit 115 via the network I/F 114. The data processing unit 115 converts the printing data into raster data printable by the printing unit 112, and the printing unit 112 forms the image on a printing medium.

[Vector Scan Function]

A function of executing a series of processes for a vectorized process (i.e., generating scanned image data by the above-mentioned copying function, saving function, transmitting function, and the like, converting the text region of the scanned image data into a Text code, and functionalizing and coding a thin-line region or graphic region) is defined as a vector scan function. In other words, a process of scanning a document and converting the obtained input image data into vector data is defined as vector scan in the first embodiment.

The vector scan function can easily generate scanned image data of a vector image.

As described above, the vector scan function converts the text part of scanned image data into a text code and outline, converts the lines and curves of a thin line, illustration, and the like into functions, and processes a table and the like as table data. Respective objects in a document can, therefore, be easily reused, unlike scanned image data of a general raster image.

For example, when the vector scan function is executed with the copying function, characters and thin lines can be reproduced at a higher image quality than in copying by raster scan.

In the use of the saving function, an image is compressed as raster data in raster scan (input from the image reading unit 110), and the capacity becomes large. However, this file capacity can be greatly decreased by functionalizing and coding data by the vector scan function.

Also in the use of the transmitting function, the transmission time can be shortened by executing the vector scan function because the obtained data capacity is very small. Further, each object is vectorized, and can be reused as a component by an external terminal on the receiving client PC 102 or the like.

An instruction to execute various functions is input from the operator to the MFP 100 via an input unit 113 and display unit 116 which are formed from a key operation unit and touch panel of the MFP 100. The series of operations are controlled by a control unit (not shown) in the data processing unit 115. The state of an operation input and image data in process are displayed on the display unit 116.

The storage unit 111 is implemented by, e.g., a large-capacity hard disk. The storage unit 111 constructs a database which stores and manages image data read by the image reading unit 110 and image data transmitted from the client 102.

In particular, according to the present invention, image data and a vector data file obtained by vectorizing the image data can be managed in correspondence with each other. At least one of the image data and vector data file may be managed depending on the application purpose.

The storage unit 111 may ensure an original buffer which stores, as original vector data, vector data corresponding to a read document image obtained by a process (to be described later), and an image editing buffer which stores a copy of the original vector data as image editing data in performing image editing based on the original vector data.

[Outline of Process]

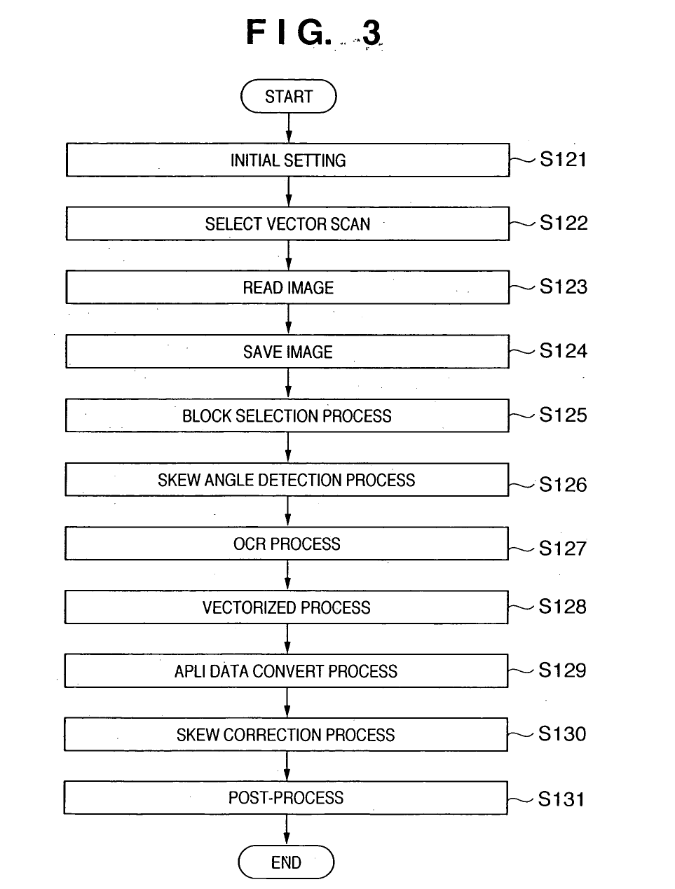

The outline of an overall process executed by the image processing system according to the first embodiment will be explained with reference to FIG. 3.

FIG. 3 is a flowchart showing the outline of the overall process executed by the image processing system according to the first embodiment of the present invention.

In step S121, a document is set on the image reading unit 110 of the MFP 100, and selection of a desired function among various functions (e.g., copying function, saving function, and transmitting function) is accepted with the function selection key of the input unit 113. The apparatus is initialized in accordance with the selection.

As one of function selections, the first embodiment provides ON/OFF setting of an “automatic block skew correction” mode in which the skew of a block (object) in an image is corrected.

In step S122, vector scan is selected on the basis of an operation with the vector scan selection key of the input unit 113.

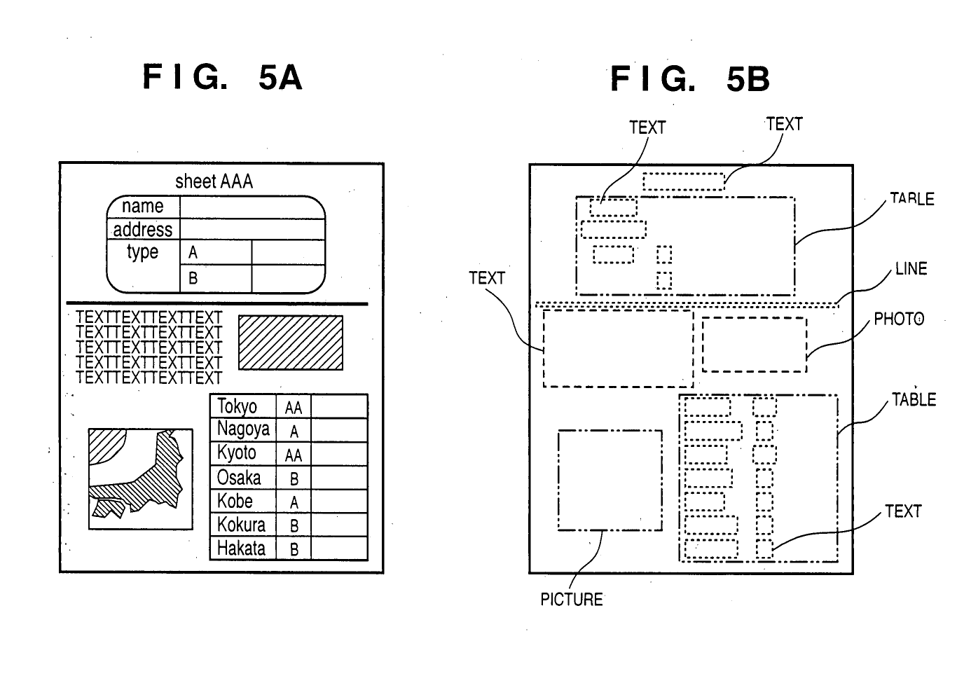

As described above, vector scan means a series of processes for a vectorized process (i.e., converting the text region of input image data (raster image data) of a read document image into a Text code, and functionalizing and coding a thin-line region or graphic region). That is, a process of scanning a document and converting the obtained input image data into vector data is defined as vector scan. Details of the vectorized process executed by vector scan will be explained with reference to FIGS. 5A and 5B and subsequent drawings.

In step S123, when a start key to activate vector scan is operated, the document image set on the image reading unit 110 is read to execute vector scan.

In vector scan, one document is raster-scanned and read to obtain, e.g., an 8-bit image signal of 600 dpi. In step S124, the image signal undergoes a pre-process by the data processing unit 115, and is saved as image data of one page in the storage unit 111.

The CPU of the data processing unit 115 executes pre-processes of the vectorized process in steps S125 and S127 for the image data saved in the storage unit 111, and performs the vectorized process in step S128.

In step S125, the data processing unit 115 performs a block selection (BS) process.

More specifically, the image signal to be processed that is stored in the storage unit 111 is divided into a text/line image part and halftone image part, and the text/line image part is further divided into blocks of paragraphs, or tables or graphics formed by lines.

The halftone image part is divided into independent objects (blocks) for so-called blocks (e.g., image parts and background parts of rectangular blocks).

In step S126, a skew angle detection process of detecting the skew of each block obtained by the block selection process of step S125 is executed.

In step S127, an OCR process is performed for the text block obtained by the block selection process of step S125.

In step S128, the size, style, and font of characters are further recognized for each text block having undergone the OCR process. The text block is converted into font data visually faithful to characters obtained by scanning the document. Table and graphic blocks formed from lines are converted into outline data and approximated by functions. Image blocks are converted into separate JPEG files as image data.

For example, a Text object is converted into font data. A Graphic (thin line and graphic) object is vectorized as outline data/approximated function. Numerical information in a table serving as a Table object is converted into font data, the table frame is vectorized as outline data/approximated function, and each numerical information is associated as cell information and coded as a table object.

An Image object is saved after executing low compression (e.g., low JPEG compression) while keeping the reading resolution of the image reading unit 110 at 600 dpi. A Background object is saved after changing the reading resolution from 600 dpi to a low resolution (e.g., a resolution of 300 dpi) and then executing high compression (e.g., high JPEG compression).

Note that high compression and low compression are respectively defined as compression at a compression ratio higher than a predetermined compression ratio (e.g., 50%) and compression at a compression ratio lower than the predetermined compression ratio.

After the end of the vectorized process, layout information of each object (block) is saved as a vector data file in the storage unit 111.

In step S129, an apli data convert process of converting the vector data obtained in step S128 into application data (apli data) of a predetermined format (e.g., an RTF (Rich Text Format) format or SVG (Scalable Vector Graphic) format) which can be processed by a word processing application is executed.

In step S130, a skew correction process of rotating each object which has been converted into vector data is executed in accordance with a preset mode. Layout information of each object is corrected in accordance with the skew correction process.

The vector data file saved in the storage unit 111 undergoes a post-process in accordance with the purpose of vector scan in step S131.

As the post-process for the copying function, the vector data file undergoes an image process such as a color process and spatial frequency correction optimal for each object, and is printed by the printing unit 112. For the saving function, the vector data file is saved and held in the storage unit 111. For the transmitting function, the vector data file is converted into a general-purpose file format (e.g., RTF (Rich Text Format) format or SVG format) so as to reuse the file at a file transmitting destination, and is transmitted to a destination (e.g., the client PC 102) via the network I/F 114.

The vector data file obtained by the above processes contains all pieces of vector information visually almost identical to the read document image in an editable format, and these pieces of vector information can be directly processed, reused, stored, transmitted, or printed again.

Since the vector data file generated by these processes expresses characters, thin lines, and the like by descriptor codes, the information amount is reduced in comparison with a case wherein image data (raster bitmap data) is simply directly processed. The storage efficiency can be increased, the transmission time can be shortened, and high-quality data can be advantageously printed/displayed.

[Description of Input Unit 113 and Display Unit 116]

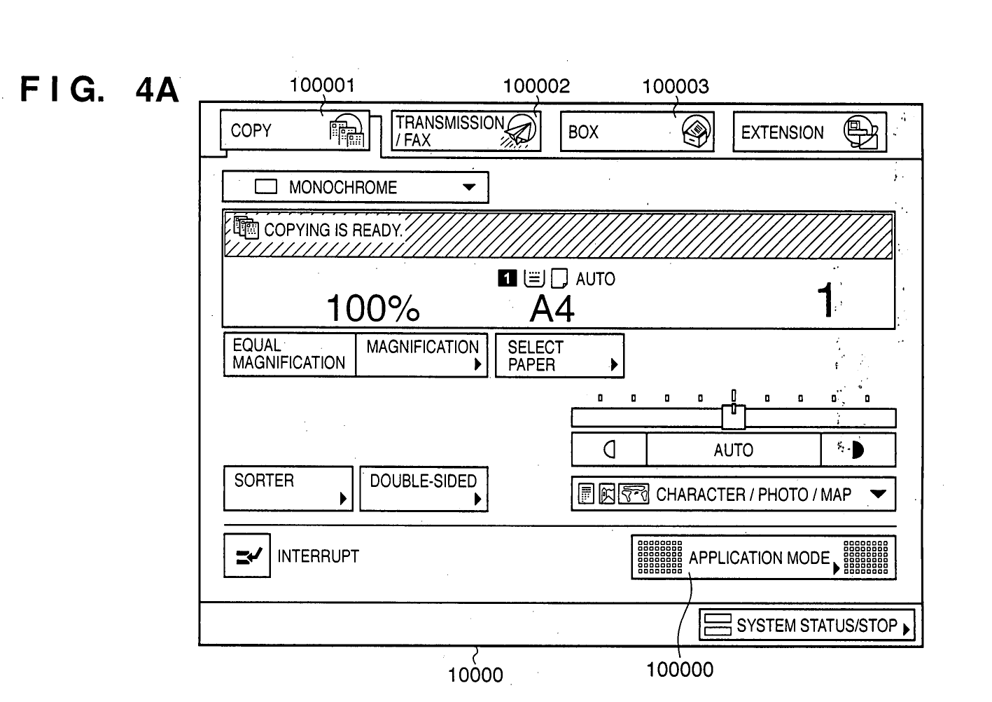

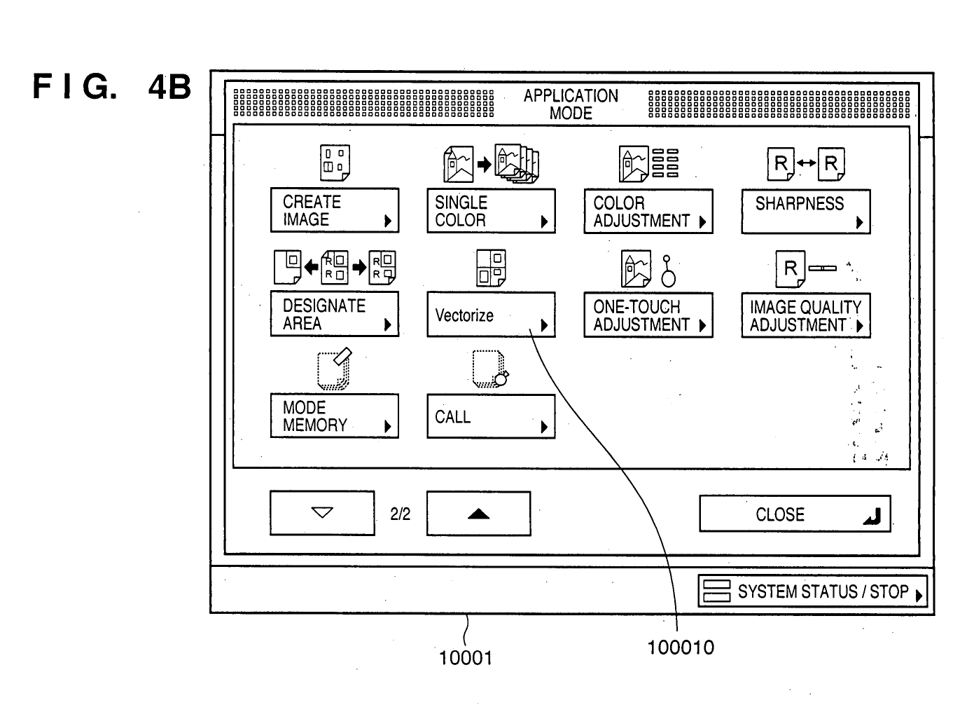

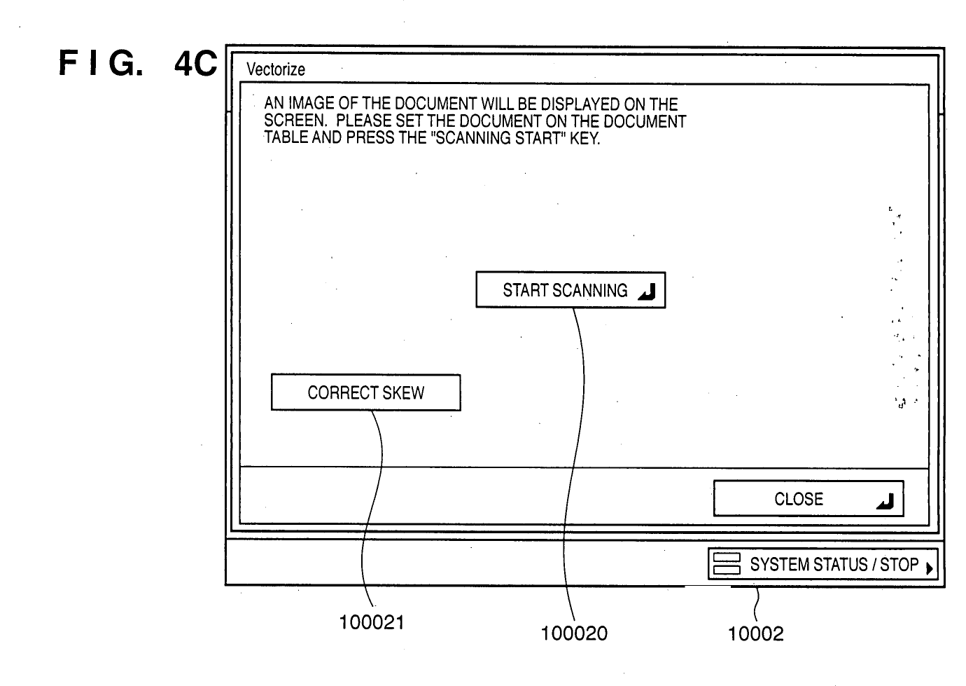

FIGS. 4A to 4C are views showing examples of operation windows according to the first embodiment of the present invention.

In particular, these operation windows are examples of ones each comprising the input unit 113 and display unit 116.

An operation window 10000 is formed by integrating the input unit 113 and display unit 116. The input unit 113 and display unit 116 comprise an LCD and touch panel in this example, but the input unit 113 may be independently formed from a hard key or mouse pointer, and the display unit 116 may be formed from a CRT or the like.

The operation window 10000 in FIG. 4A is the basic operation window of the MFP 100 according to the first embodiment. In the example of the operation window 10000, an application mode key 100000 includes selection of the vector scan function in the first embodiment.

When a key 100001 is touched to select the copying function, a key 100002 is touched to select the transmitting function (transmission/FAX function), or a key 100003 is touched to select the saving function (box function), the operation window 10000 is switched to a window display corresponding to the selected function. This example illustrates a display example when the copying function is selected.

When the application mode key 100000 is touched, the operation window 10000 is switched to an application mode window 10001 in FIG. 4B that is formed from various modes prepared as application modes by the MFP 100.

In the application mode window 10001 of FIG. 4B, a Vectorize key 100010 is a selection key which enables the above-mentioned vector scan function (step S122 in FIG. 3). When the Vectorize key 100010 is touched, an operation window 10002 in FIG. 4C is displayed.

In the operation window 10002, a scanning start key 100020 is used to give an instruction to start scanning. When the key is touched, a document is scanned. A skew correction key 100021 is used to set whether to execute the skew angle detection process (step S126) for an object in a document subjected to vector scan. That is, the skew correction key 100021 can set the ON/OFF state of the “automatic block skew correction” mode.

In executing the skew angle detection process, the skew correction key 100021 is touched, and then the scanning start key 100020 is touched to start scan operation.

The skew correction key 100021 need not be provided on the operation window 10002, and may be provided on another dedicated window. Also, the “automatic block skew correction” mode may be set ON as a default setting.

<Block Selection Process>

Details of the block selection process in step S125 of FIG. 3 will be explained.

In the block selection process, for example, a raster image in FIG. 5A is recognized as meaningful blocks, as shown in FIG. 5B. The attributes (e.g., text/graphic/image/table) of the blocks are determined, and the image is divided into blocks having different attributes.

An example of the block selection process will be described below.

An input image is binarized into a monochrome image, and edge tracking is performed to extract a cluster of pixels surrounded by a black pixel edge. In a cluster of black pixels in a large area, edge tracking is also performed for internal white pixels to extract a cluster of white pixels. Further, a cluster of black pixels is recursively extracted from the cluster of white pixels with a predetermined area or more.

Obtained clusters of black pixels are classified by size and shape into blocks having different attributes. For example, a block having an aspect ratio of almost 1 and a size of a predetermined range is defined as a pixel cluster corresponding to a text. A part of adjacent characters which can be neatly grouped is defined as a text block, and a plane pixel cluster is defined as a line block. A range of a black pixel cluster which neatly contains rectangular white pixel clusters with a predetermined size or more is defined as a table block. A region where indefinite pixel clusters scatter is defined as a photo block. A pixel cluster with another arbitrary shape is defined as a picture block.

In the block selection process, a block ID which identifies each block is issued, and the attribute (image, text, or the like) of each block, the size, the position (coordinates) in the original document, and the block are associated and stored as block information in the storage unit 111. The block information is used in the vectorized process of step S128 (to be described later in detail).

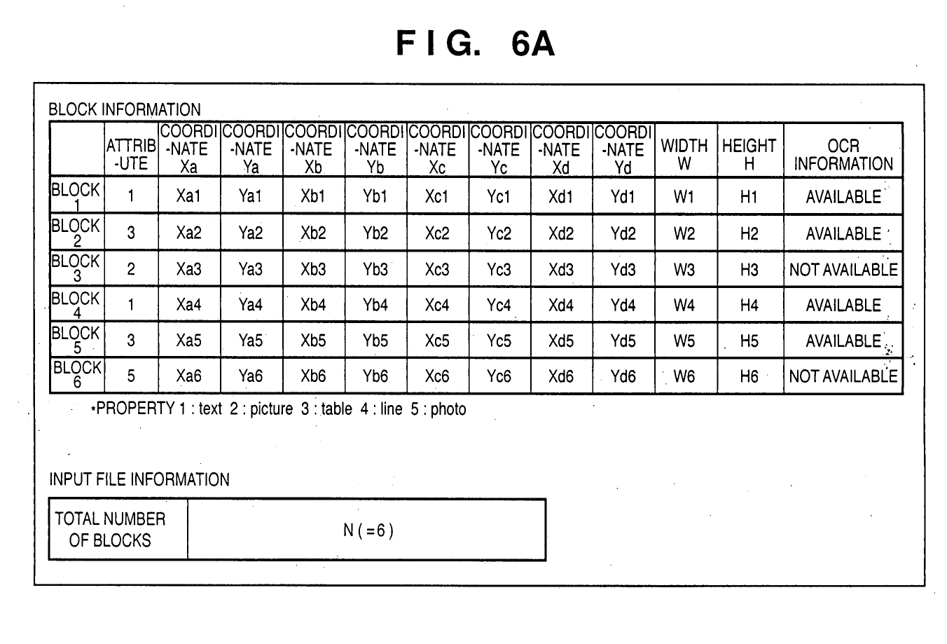

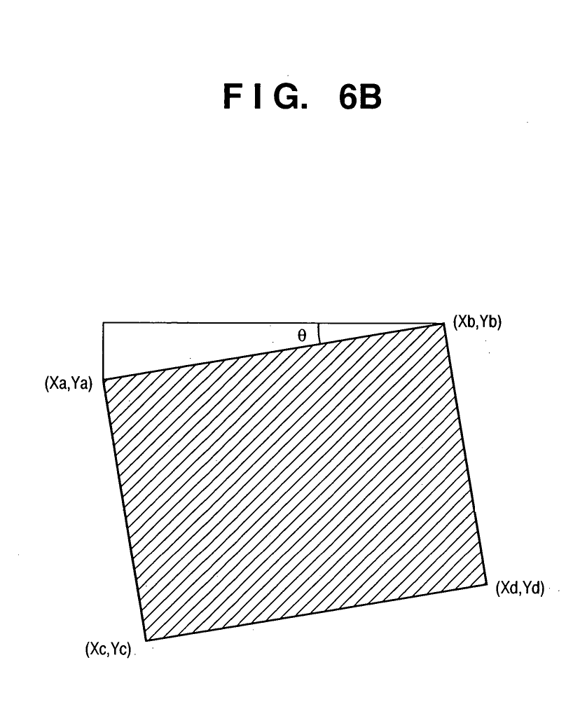

An example of block information will be described with reference to FIG. 6A.

FIG. 6A is a view showing an example of block information according to the first embodiment of the present invention.

As shown in FIG. 6A, the block information comprises a block attribute which indicates the attribute of each block (1: TEXT; 2: GRAPHIC; 3: TABLE; 4: LINE; and 5: IMAGE), the position coordinates (Xa, Ya) to (Xd, Yd) of the four corners of a block, a block width W, a block height H, and the presence/absence of block OCR information (text data).

The block position coordinates (Xa, Ya) indicate, e.g., the position coordinates of an upper left corner using those of the upper left corner of a document image as a start point (0, 0). Also, (Xb, Yb) indicate the position coordinates of an upper right corner, (Xc, Yc) indicate those of a lower left corner, and (Xd, Yd) indicate those of a lower right corner. Each of the width W and height H is represented by, e.g., the number of pixels. In the block selection process, input file information indicating the number N of blocks present in a document image (input file) is generated in addition to the block information. In the example of FIG. 6A, the input file information N becomes equal to 6.

<Skew Angle Detection Process>

Details of the skew angle detection process in step S126 of FIG. 3 will be explained.

The skew angle detection process detects the skew angle of each block by referring to coordinate information of the block in block information of FIG. 6A.

For example, assuming that the coordinates of a given block are represented by (Xa, Ya) to (Xd, Yd), as shown in FIG. 6B, a skew angle θ of the upper side of the block with respect to a predetermined direction (e.g., horizontal direction: a direction which coincides with the upper side of a document image read with a normal orientation) is represented by tan⁻¹((Yb−Ya)/(Xb−Xa)). The skews of the lower, right, and left sides of the block are also similarly calculated, and the skew (angle) of the block with respect to the horizontal direction can be detected.

Especially when a block is rectangular, the skews of the respective sides are equal to each other. One of the four detected angles or their average value is temporarily stored as the skew angle of the block in the storage unit 111, and the same process is also performed for the remaining blocks.

Note that the block skew angle detection method is not limited to the above one as far as the skew angle of each block can be detected.

<OCR Process>

Details of the OCR process in step S127 of FIG. 3 will be explained.

A character recognition process is executed using a known OCR technique.

“Character Recognition Process”

In the character recognition process, a character image extracted from a text block for each character is recognized using one of pattern matching methods to obtain a corresponding text code. In this character recognition process, an observation feature vector obtained by converting a feature acquired from a character image into a several-ten-dimensional numerical value string is compared with a dictionary feature vector obtained in advance for each character type, and a character type with a shortest distance is output as a recognition result.

Various known methods are available for feature vector extraction. For example, a method of dividing a character into a mesh pattern, and counting character lines in respective meshes as line elements depending on their directions to obtain a (mesh count)-dimensional vector as a feature is known.

When a text block undergoes the character recognition process, the writing direction (horizontal or vertical) is determined for that text block, character strings are extracted in the corresponding directions, and characters are then extracted from the character strings to obtain character images.

Upon determining the writing direction (horizontal or vertical), horizontal and vertical projections of pixel values in that text block are calculated, and if the variance of the horizontal projection is larger than that of the vertical projection, that text block can be determined as a horizontal writing block; otherwise, that block can be determined as a vertical writing block. Upon decomposition into character strings and characters, for a text block of horizontal writing, lines are extracted using the horizontal projection, and characters are extracted based on the vertical projection for the extracted line. For a text block of vertical writing, the relationship between the horizontal and vertical parameters may be exchanged.

Note that a character size can be detected with the character recognition process.

<Vectorized Process>

Details of the vectorized process in step S128 of FIG. 3 will be explained.

A font recognition process is done for each character of a text block obtained by the OCR process in step S127.

“Font Recognition Process”

A plurality of dictionary feature vectors for the number of character types used in the character recognition process are prepared in correspondence with character shape types, i.e., font types, and a font type is output together with a text code upon matching, thus recognizing the font of a character.

“Vectorized Process for Text”

Using a text code and font information obtained by the character recognition process and font recognition process, and outline data prepared for each text code and font, information of a text part is converted into vector data. If a document image is a color image, the color of each character is extracted from the color image and recorded together with vector data.

With the above-mentioned processes, image information which belongs to a text block can be converted into vector data with a nearly faithful shape, size, and color.

“Vectorized Process for Part Other than Text”

For picture, line, and table blocks other than a text block, outlines of pixel clusters extracted in each block are converted into vector data.

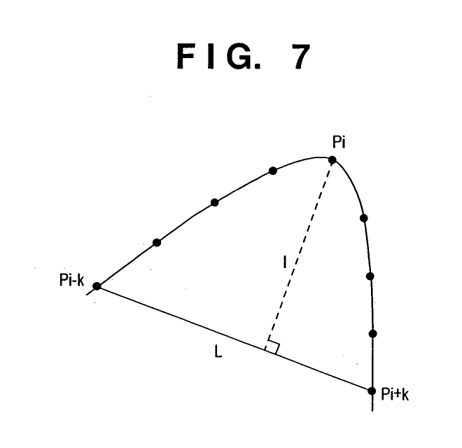

More specifically, a point sequence of pixels which form an outline is divided into sections at a point which is considered as a corner, and each section is approximated by a partial line or curve. The corner means a point corresponding to a maximal curvature, and the point corresponding to the maximal curvature is obtained as a point where a distance between an arbitrary point PI and a chord which is drawn between points Pi−k and Pi+k separated k points from the point Pi in the left and right directions becomes maximal, as shown in FIG. 7.

Furthermore, let R be the chord length/arc length between Pi−k and Pi+k. Then, a point where the value R is equal to or smaller than a threshold value can be considered as a corner. Sections obtained after division at each corner can be vectorized using a method of least squares or the like with respect to a point sequence for a line, and a ternary spline function or the like for a curve.

When an object has an inside outline, it is similarly approximated by a partial line or curve using a point sequence of a white pixel outline extracted in the block selection process.

As described above, using partial line approximation, an outline of a graphic with an arbitrary shape can be vectorized. When a document image is a color image, the color of a graphic is extracted from the color image and recorded together with vector data.

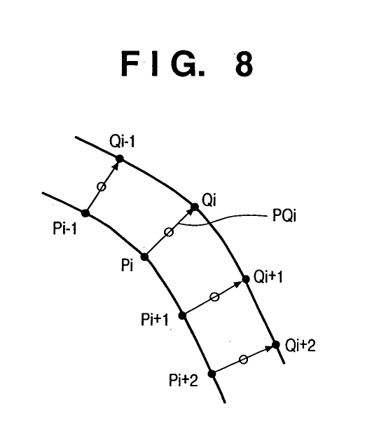

Furthermore, when an outside outline is close to an inside outline or another outside outline in a given section, as shown in FIG. 8, two outlines may be combined to express a line with a given width.

More specifically, lines are drawn from respective points Pi on a given outline to points Qi on another outline, each of which has a shortest distance from the corresponding point. When the distances PQi maintain a constant value or less on the average, the section of interest is approximated by a line or curve using the middle points of the distances PQi as a point sequence, and the average value of the distances PQi is set as the width of that line or curve. A line or a table ruled line as a set of lines can be efficiently vectorized as a set of lines having a given width.

Note that vectorization using the character recognition process for a text block has been explained. A character which has the shortest distance from a dictionary as a result of the character recognition process is used as a recognition result. When this distance is equal to or larger than a predetermined value, the recognition result does not always match an original character, and a wrong character having a similar shape is often recognized.

Therefore, in the first embodiment, such a text block is handled in the same manner as a general line image, and is converted into outline data. That is, even a character that causes a recognition error in the conventional character recognition process can be prevented from being vectorized to a wrong character, but can be vectorized on the basis of outline data which is visually faithful to image data.

Note that an image block is not vectorized, and is output as image data.

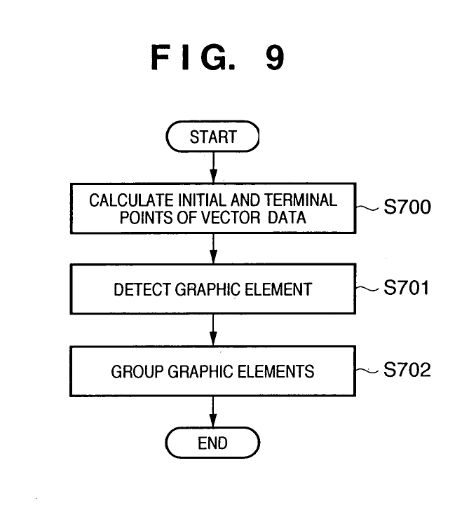

A grouping process of grouping vector data obtained in the vectorized process for each graphic block will be described below with reference to FIG. 9.

FIG. 9 is a flowchart showing the vector data grouping process according to the first embodiment of the present invention.

A process of grouping vector data for each graphic block will be described particularly with reference to FIG. 9.

In step S700, initial and terminal points of each vector data are calculated. In step S701, using the initial point information and terminal point information of respective vectors, a graphic element is detected.

Detecting a graphic element is to detect a closed graphic formed by partial lines. The detection is made by applying the principle that each vector which forms a closed shape has vectors coupled to its two ends.

In step S702, other graphic elements or partial lines present in the graphic element are grouped to set a single graphic object. If other graphic elements or partial lines are not present in the graphic element, that graphic element is set as a graphic object.

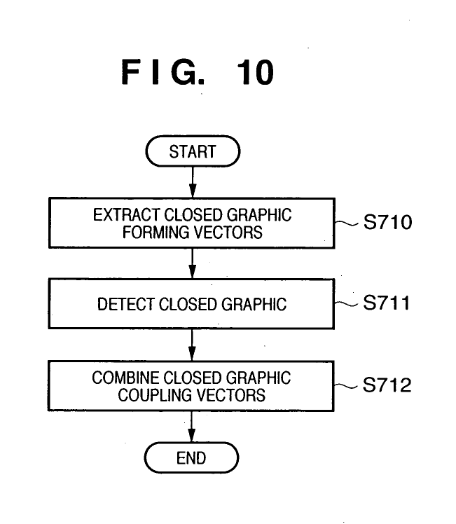

Details of the process in step S701 of FIG. 9 will be described with reference to FIG. 10.

FIG. 10 is a flowchart showing details of the process in step S701 according to the first embodiment of the present invention.

In step S710, closed graphic forming vectors are extracted from vector data by excluding unwanted vectors, two ends of which are not coupled to other vectors.

In step S711, an initial point of a vector of interest of the closed graphic forming vectors is set as a start point, and vectors are traced clockwise in turn. This process is made until the start point is reached, and all passing vectors are grouped as a closed graphic that forms one graphic element. Also, all closed graphic forming vectors present in the closed graphic are grouped. Furthermore, an initial point of a vector which is not grouped yet is set as a start point, and the same process is repeated.

Finally, in step S712, of the unwanted vectors excluded in step S710, those (closed-graphic-coupled vectors) which join the vectors grouped as the closed graphic in step S711 are detected and grouped as one graphic element.

With the above-mentioned process, a graphic block can be handled as an independently reusable graphic object.

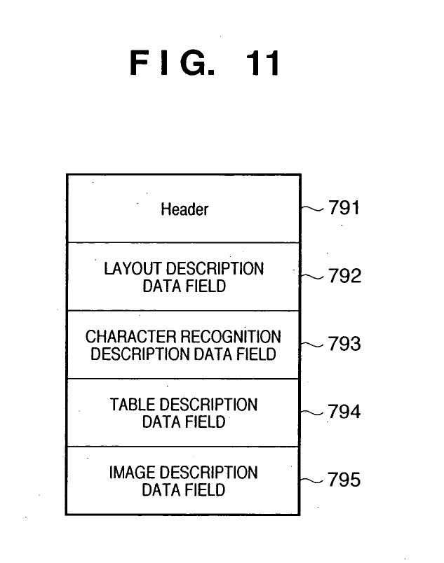

Data obtained by the block selection process in step S125 of FIG. 3, the OCR process in step S127, and the vectorized process in step S128 are converted into a file of an intermediate data format shown in FIG. 11. This data format is called a document analysis output format (DAOF).

The data structure of the DAOF will be described with reference to FIG. 11.

FIG. 11 is a view showing the data structure of the DAOF according to the first embodiment of the present invention.

Referring to FIG. 11, a header 791 holds information associated with a document image to be processed. A layout description data field 792 holds attribute information and rectangle address information of respective blocks which are recognized for respective attributes such as Text (text), Title (title), Caption (caption), Lineart (line image), Picture (natural image), Frame (frame), and Table (table).

A character recognition description data field 793 holds character recognition results obtained by performing character recognition of Text blocks such as Text, Title, and Caption.

A table description data field 794 stores details of the structure of Table blocks. An image description data field 795 holds image data of Graphic blocks, Image blocks, and the like extracted from the image data.

The DAOF itself is often stored as a file in place of intermediate data. However, in the state of a file, a general word processing application cannot reuse individual objects (blocks).

Hence, in the first embodiment, the apli data convert process of converting the DAOF into apli data which can be used by a word processing application is executed after the vectorized process in step S128 of FIG. 3 or as part of the post-process in step S131 of FIG. 3.

<Apli Data Convert Process>

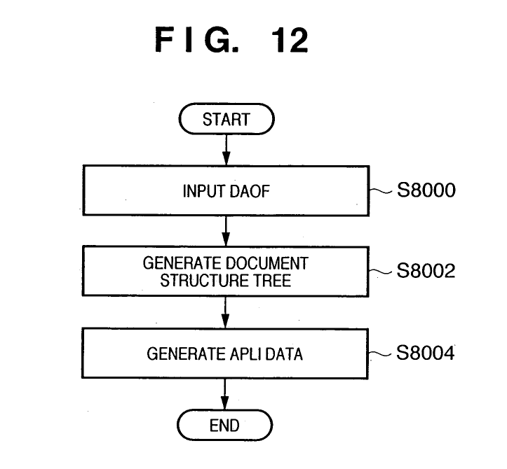

Details of the apli data convert process will be explained with reference to FIG. 12.

FIG. 12 is a flowchart showing details of the apli data convert process according to the first embodiment of the present invention.

In step S8000, DAOF data is input. In step S8002, a document structure tree which serves as a basis of apli data is generated. In step S8004, actual data in the DAOF are input based on the document structure tree, thus generating actual apli data.

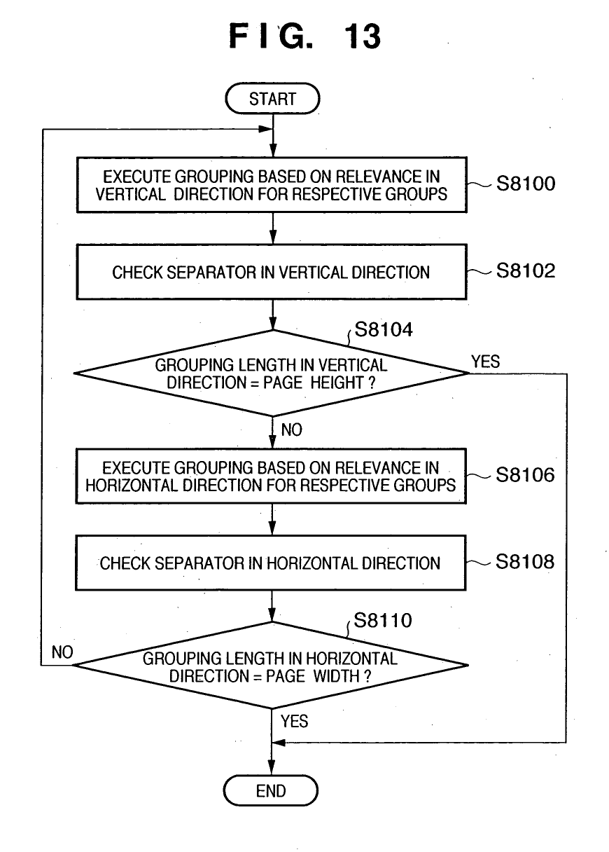

Details of the process in step S8002 in FIG. 12 will be described with reference to FIG. 13.

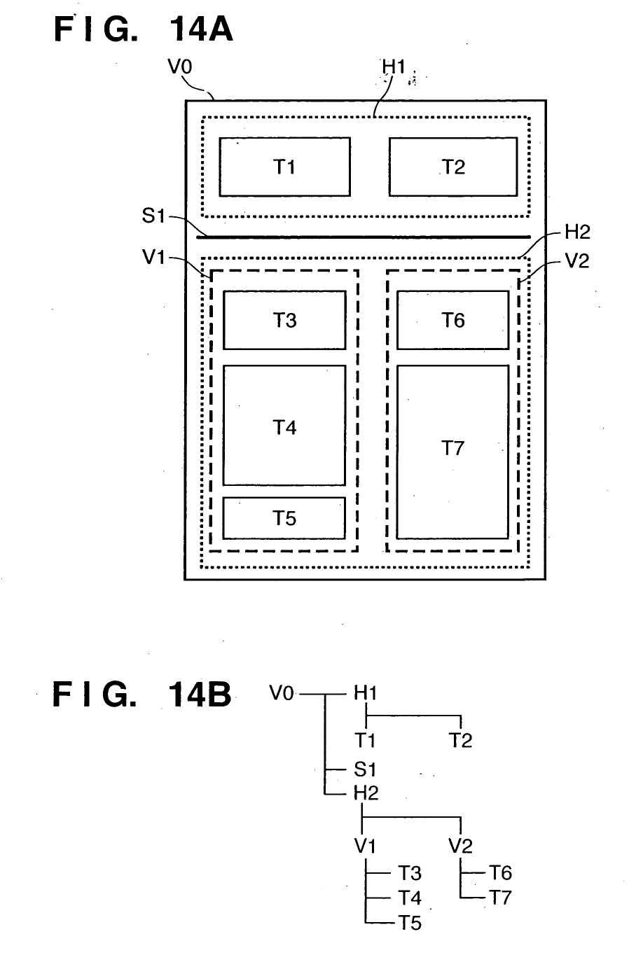

FIG. 13 is a flowchart showing details of the process in step S8002 according to the first embodiment of the present invention. FIGS. 14A and 14B are explanatory views showing a document structure tree according to the first embodiment of the present invention.

In the process shown in FIG. 13, as a basic rule of the overall control, the flow of process transits from a microblock (single block) to a macroblock (a set of blocks).

In this case, a block indicates a microblock and macroblock.

In step S8100, re-grouping is done for respective blocks on the basis of relevance in the vertical direction. Immediately after the flow starts, determination is made for respective microblocks.

Note that relevance can be defined by determining whether the distance between neighboring blocks is small, blocks have nearly the same block widths (heights in the horizontal direction), and the like. Information of the distances, widths, heights, and the like can be extracted with reference to the DAOF.

FIG. 14A shows the page configuration of an actual document image, and FIG. 14B shows a document structure tree of that page. As a result of the process in step S8100, blocks T3, T4, and T5 are determined to form one group V1, blocks T6 and T7 are determined to form one group V2, and these groups are generated as those which belong to an identical layer.

In step S8102, the presence/absence of a vertical separator is determined. Physically, a separator is a block which has a line attribute in the DAOF. Logically, a separator is an element which explicitly divides blocks in a word processing application. Upon detection of a separator, a group is re-divided in the identical layer.

It is then determined in step S8104 using a group length if no more divisions are present. More specifically, it is determined whether the group length in the vertical direction agrees with the page height of the document image. If the group length in the vertical direction agrees with the page height (YES in step S8104), the process ends. On the other hand, if the group length in the vertical direction does not agree with the page height (NO in step S8104), the flow advances to step S8106.

The document image in FIG. 14A has no separator, and its group lengths do not agree with the page height. Hence, the flow advances to step S8106.

In step S8106, re-grouping is done for respective blocks on the basis of relevance in the horizontal direction. In this process as well, the first determination immediately after the start is done for respective microblocks. The definitions of relevance and its determination information are the same as those in the vertical direction.

In the document image of FIG. 14A, the blocks T1 and T2 generate a group H1, and the groups V1 and V2 generate a group H2. The groups H1 and H2 are generated as those which belong to an identical layer one level higher than the groups V1 and V2.

In step S8108, the presence/absence of a separator in the horizontal direction is determined. Since FIG. 14A includes a separator S1 in the horizontal direction, that separator is registered in a document structure tree, thus generating the layers H1, S1, and H2.

It is determined in step S8110 using a group length in the horizontal direction if no more divisions are present. More specifically, it is determined whether the group length in the horizontal direction agrees with a page width. If the group length in the horizontal direction agrees with the page width (YES in step S8110), the process ends. On the other hand, if the group length in the horizontal direction does not agree with the page width (NO in step S8110), the flow returns to step S8100 to repeat the processes from step S8100 in an upper layer by one level.

In FIG. 14A, since the group length in the horizontal direction agrees with the page width, the process ends in step S8110, and an uppermost layer V0 that represents the entire page is finally appended to the document structure tree.

After the document structure tree is completed, application data is generated based on the document structure tree in step S8004 of FIG. 13.

A practical example of apli data in FIG. 14A is generated as follows.

That is, since the group H1 includes the two blocks T1 and T2 in the horizontal direction, it is output as two columns. After internal information of the block T1 (with reference to the DAOF, text as the character recognition result, image, and the like) is output, a new column is set, and internal information of the block T2 is output. After that, the separator S1 is output.

Since the group H2 includes the two blocks V1 and V2 in the horizontal direction, it is output as two columns. Internal information of the block V1 is output in the order of the blocks T3, T4, and T5, and a new column is set. Then, internal information of the block V2 is output in the order of the blocks T6 and T7.

In this manner, the convert process from DAOF into apli data can be done.

<Skew Correction Process>

Details of the skew correction process in step S130 of FIG. 3 will be explained.

The following process is executed when the “automatic block skew correction” mode is set ON.

The skew of each block is corrected by referring to the skew angle of the block that is detected in step S126 and rotating the block by the skew angle in a direction opposite to the skew direction. This skew correction can keep the layout between blocks unchanged by rotating each block so as not to change its central position.

When each block is formed from vector data, like the first embodiment, this rotation process can be easily executed.

For example, to rotate a graphic block of vector data in the SVG format, a rotation angle “angle” parameter is designated using a rotate command.

If blocks having undergone skew correction overlap each other after skew correction, the overlapping blocks are reduced to prevent overlapping between them.

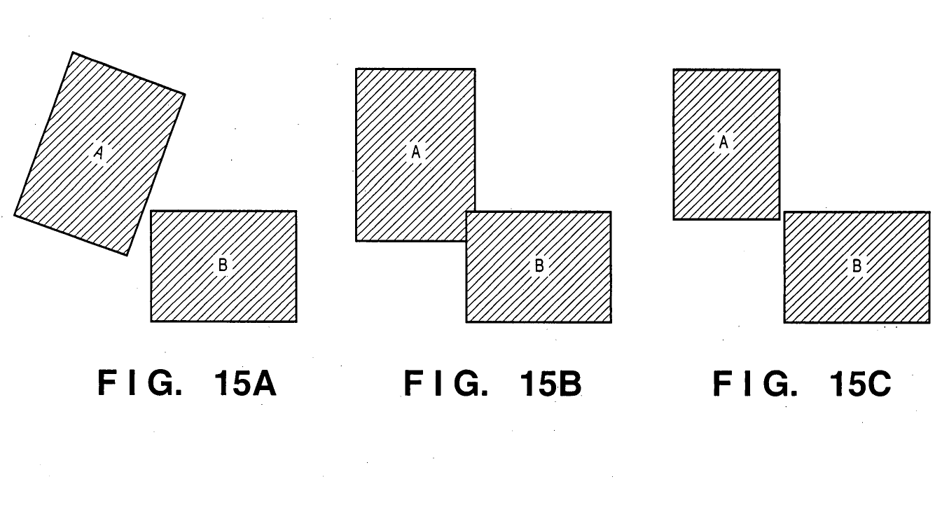

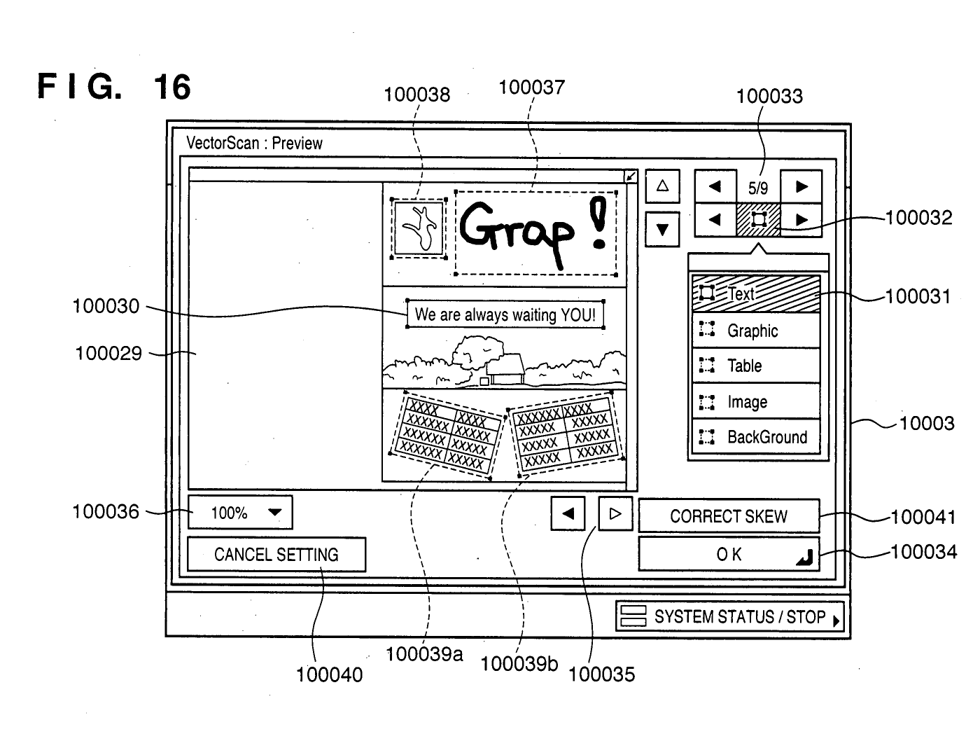

For example, blocks A and B before the skew correction process in FIG. 15A change to overlap each other upon performing the skew correction process for block A, as shown in FIG. 15B. In this case, block A is reduced to cancel overlapping between blocks A and B, as shown in FIG. 15C.

For example, a scale command is used for vector data in the SVG format to designate the enlargement/reduction ratios of block A in the x and y directions as parameters.

In order to prevent overlapping between blocks, block A may be translated after the skew correction process. In this case, block A is desirably translated within a range where block A does not overlap another block or protrude from the document frame.

For example, a translate command is used for vector data in the SVG format to designate the moving amounts of block A in the x and y directions as parameters.

Similarly, block B can also be reduced. When an arbitrary block in a document image is reduced at a predetermined reduction ratio, the remaining blocks can also be reduced at the same reduction ratio, more preferably maintaining the overall layout balance.

As described above, according to the first embodiment, an image is divided into a plurality of objects by attribute, the skew of each obtained object is detected, and vector data corresponding to the object is generated. Each object undergoes skew correction using the vector data on the basis of the detected skew.

Since skew correction uses vector data, it can be easily executed for each object at high precision and a high speed. By managing an image in the vector data format, the image can be easily reused (reedited) without any degradation.

Skew detection of each object is executed on the basis of block information of the object that is obtained by the block selection process, but may be executed on the basis of vector data of the object after the vectorized process.

### Second Embodiment

In the first embodiment, the skew correction process is automatically executed when the “automatic block skew correction” mode is set ON and vector scan is executed. To the contrary, in the second embodiment, an image after the block selection process is previewed after reading the image, and the status of the vectorized process and that of the skew correction process can be confirmed in advance before final vector data is generated.

In the second embodiment, when a scanning start key 100020 is touched in an operation window 10002 of FIG. 4C, scan operation starts to read a document. After the end of reading the document, the display switches to an operation window 10003 in FIG. 16.

In the second embodiment, processes up to the block selection process in step S125 of FIG. 3 are executed for a read document image input in S123 of FIG. 3, and the process result (result of the objectification process) is temporarily stored in, e.g., a storage unit 111.

The operation window 10003 in FIG. 16 displays an image 100029 containing the process result, and objects which form the image 100029 are enclosed and displayed in rectangular frames by respective units (attributes).

The objects are represented with the rectangular frames of different colors which depend on their attributes automatically recognized in the block selection process in step S125 of FIG. 3.

For example, if rectangular frames enclosing respective objects are represented in different colors (e.g., red for TEXT (text) and yellow for IMAGE (photo)), the attribute-specific objects obtained in the block selection process can easily recognized. This improves the visibility of the operator. Instead of variations in color, rectangular frames may be differentiated from each other by variations in any other display style such as the width or shape (dotted frame). Alternatively, each object may be screened.

An image (platen image) obtained by reading the document with an image reading unit 110 is displayed as the image 100029 in the initial state. The size of the image can be enlarged/reduced by using an enlargement/reduction key 100036, as needed. Assume that the display contents of the enlarged image 100029 exceed the display area in size, and the entire contents cannot be viewed. In this case, the invisible portion can be confirmed by scrolling across and down the image 100029 using scroll keys 100035.

FIG. 16 shows a state wherein a text object 100030 (character string “We are always waiting YOU!”) at the center of the image 100029 is selected. In FIG. 16, the object in a selected state is enclosed in a solid rectangular frame of a color indicating its attribute (in this case, red) while the remaining objects in an unselected state are enclosed in dashed rectangular frames of colors indicating their attributes. By differentiating between the display style of a rectangular frame in the selected state and that of a rectangular frame in the unselected state, the selected state/unselected state of each object can be confirmed with ease.

In this example, the text object 100030 is enclosed in a red solid rectangular frame; a graphic object 100037, a blue dashed rectangular frame; an image object 100038, a yellow dashed rectangular frame; and table objects 100039a and 100039b, green dashed rectangular frames. The remaining object is a background object.

The background object is an image part left after extracting the objects constituting the image 100029 and is not enclosed in a rectangular frame. However, for background designation, the background image may be enclosed in a rectangular frame similarly to other objects. In this case, the visibility of the background object may be increased by hiding other objects.

As methods of selecting an object to be edited (e.g., editing of a character string in the case of a text object and color adjustment in the case of a graphic object), there are available a method of directly touching a region within, e.g., the text object 100030 and a method of designating the object using object selection keys 100032. By either method, the rectangular frame of a selected object becomes a solid one while the rectangular frames of the unselected objects become dashed ones.

At the same time, one of object attribute keys 100031 (Text is selected in this example, and others are Graphic, Table, Image, and Background) corresponding to the attribute of the selected object is selected. In this case, to show its selected state, the corresponding object attribute key is screened. Other display styles such as hatched display, blinking display, and the like can be adopted as far as they can represent the selected state/unselected state.

Assume that a document containing a plurality of pages is read using an ADF. In the initial state, the image of the first one of the plurality of pages is displayed in the operation window 10003. As for the subsequent pages, the image can be switched to the image of a desired page using page designation keys 100033.

Setting of whether the vectorized result of a selected object is OK (setting for determining (saving) vector data) is decided with an OK key 100034. When the OK key 100034 is touched, a vectorized process corresponding to one or more objects selected from the displayed image 100029 is executed. When a setting cancel key 100040 is touched, various settings made in the operation window 10003 are discarded, and the operation window 10003 returns to a basic window 10000 of FIG. 4A.

When a skew correction key 100041 is touched, the skew angle of each block (object) is detected to execute a skew correction process for the block.

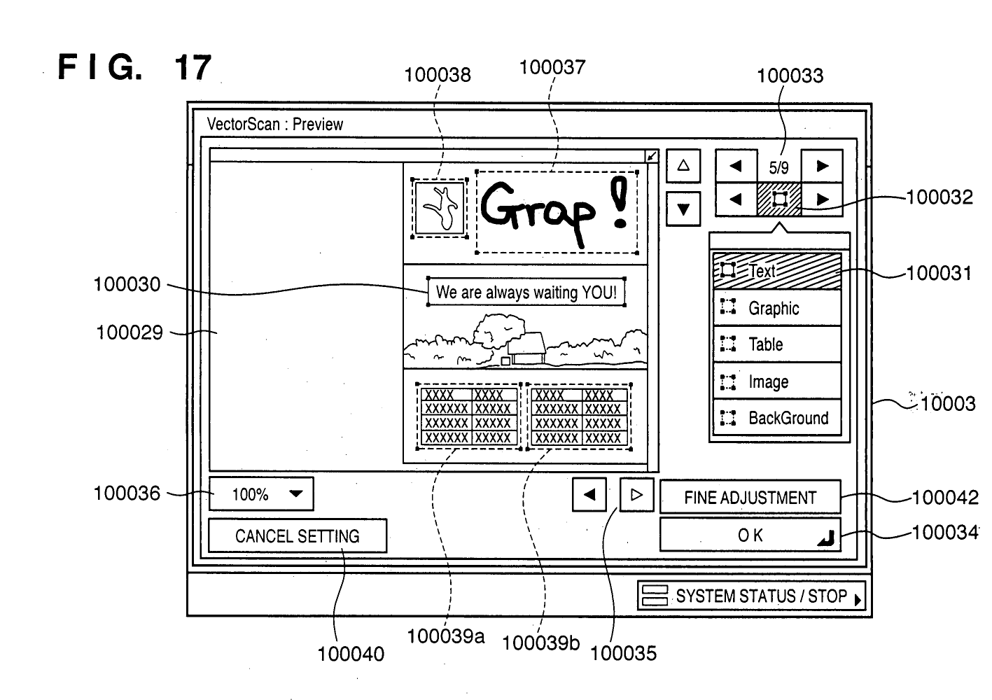

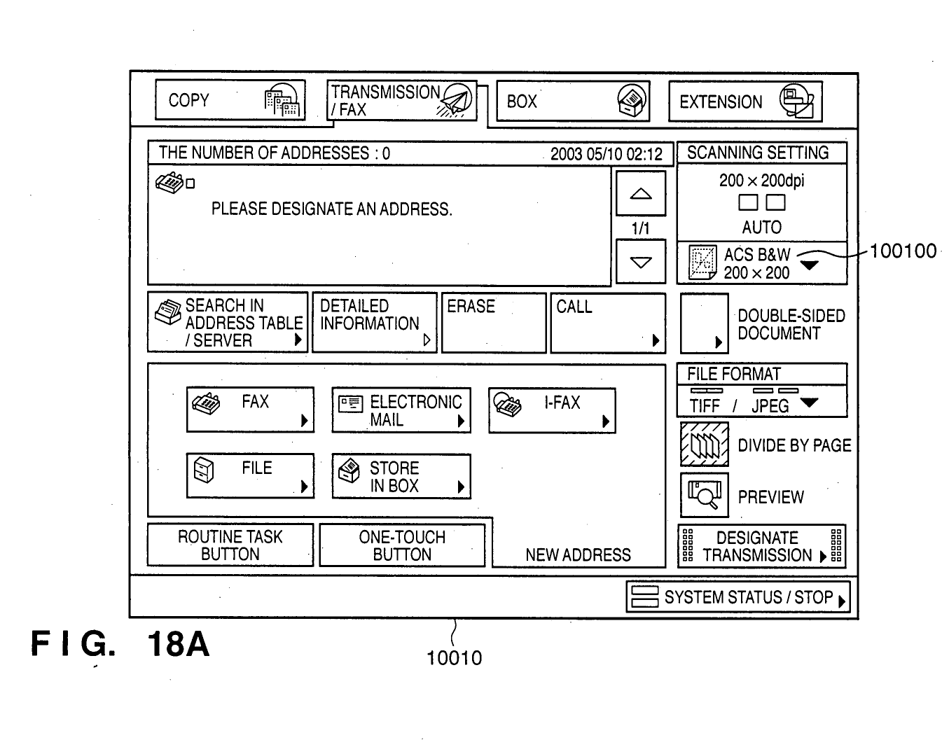

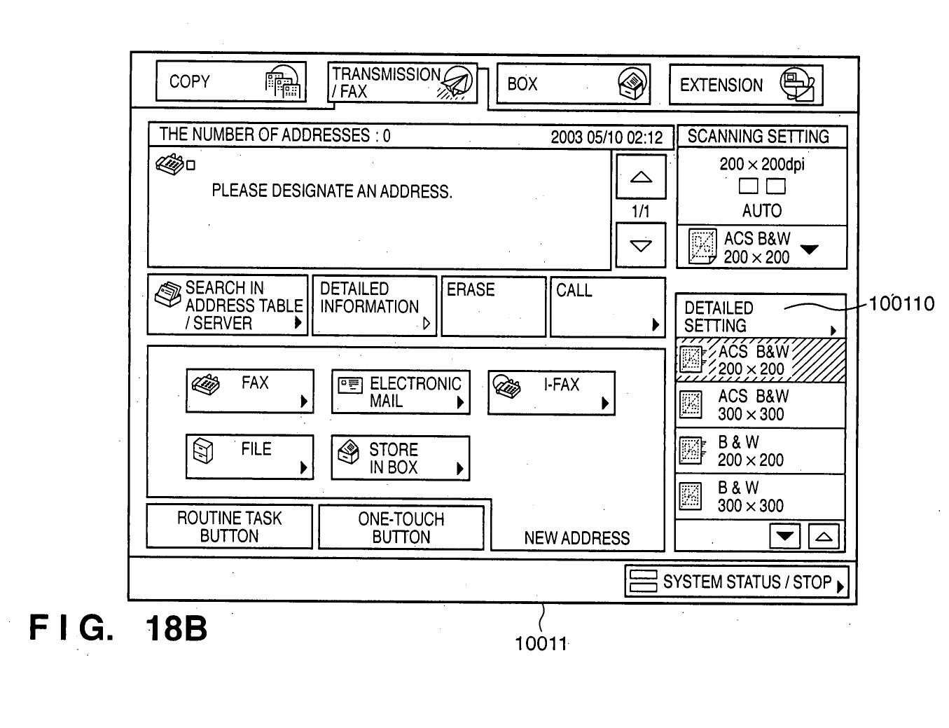

An operation window 10004 in FIG. 17 is displayed in response to touch to the skew correction key 100041.

As shown in FIG. 17, the skews of the table objects 100039a and 100039b in the operation window of FIG. 16 are corrected in the operation window 10004. When the OK key 100034 is touched, a vectorized process corresponding to a corrected block (object) is executed.

A fine adjustment key 100042 in FIG. 17 is a window for invoking a fine adjustment window (not shown) to finely adjust the position of a skew-corrected block. The fine adjustment window allows the user to finely adjust the position and skew of each skew-corrected block.

As the fine adjustment method, for example, the rotation angle or moving amount may be directly input as a numerical value, or a key for the rotation direction or moving direction that is provided in the fine adjustment window may be operated.

Images before and after the skew correction process are displayed in different operation windows, but can also be displayed for comparison in the same window.

[Transmission/FAX Operation Specification]

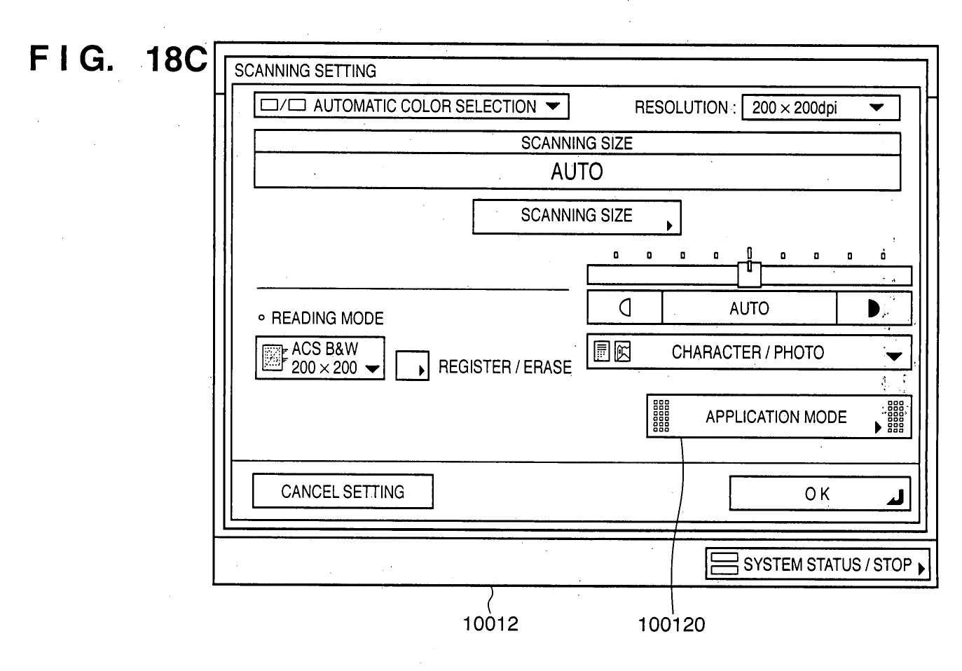

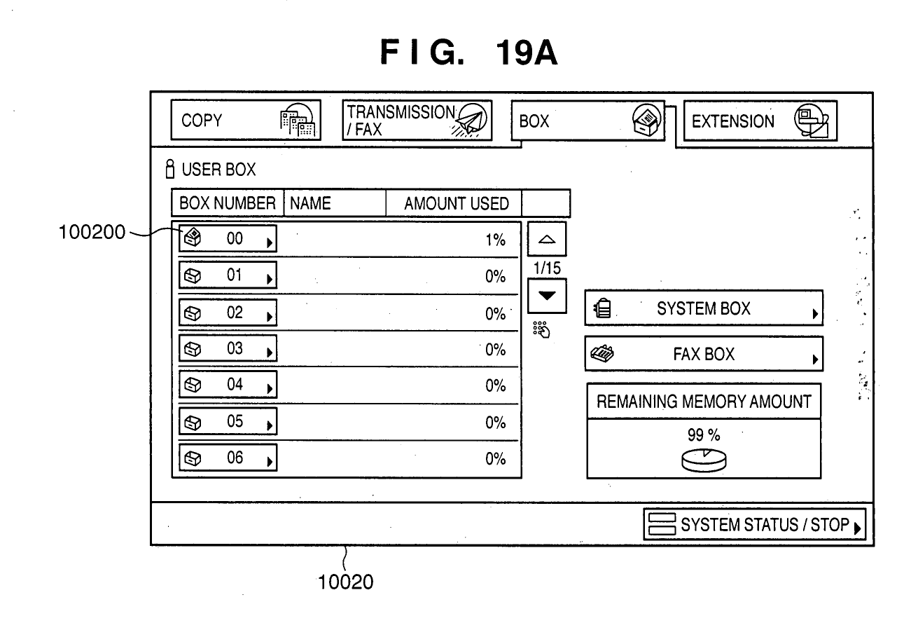

An operation window for file transmission/FAX will be described with reference to FIGS. 18A to 18C.

FIGS. 18A to 18C are views showing examples of operation windows according to the second embodiment of the present invention.

An operation window 10010 in FIG. 18A is a basic window for file transmission/FAX. To perform a process using the operation window 10010, scanning setting for scanning a document image to be processed by an MFP 100 needs to be performed. Scanning setting can be performed from a scanning setting pull-down menu 100100. When the scanning setting pull-down menu 100100 is touched, a pull-down menu is displayed, as in an operation window 10011 in FIG. 18B. In this pull-down menu, e.g., 200×200 dpi or 300×300 dpi can be selected as the scanning setting.

When a detailed setting key 100110 of the operation window 10011 is then touched, an operation window 10012 (scanning setting window) in FIG. 18C is displayed. When an application mode key 100120 of the operation window 10012 is touched, an operation window 10001 in FIG. 4B is displayed.

[Box Operation Specification]

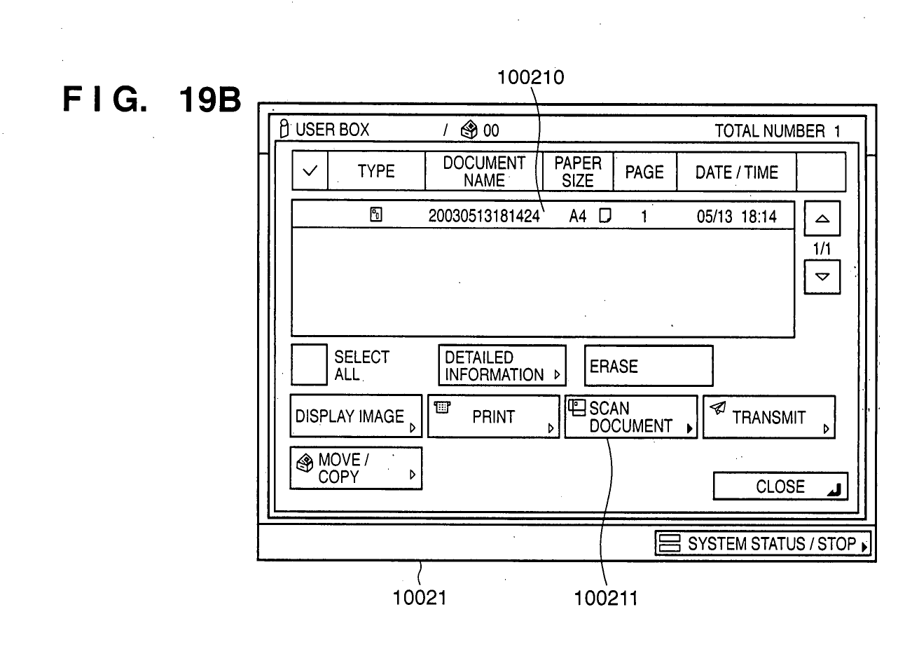

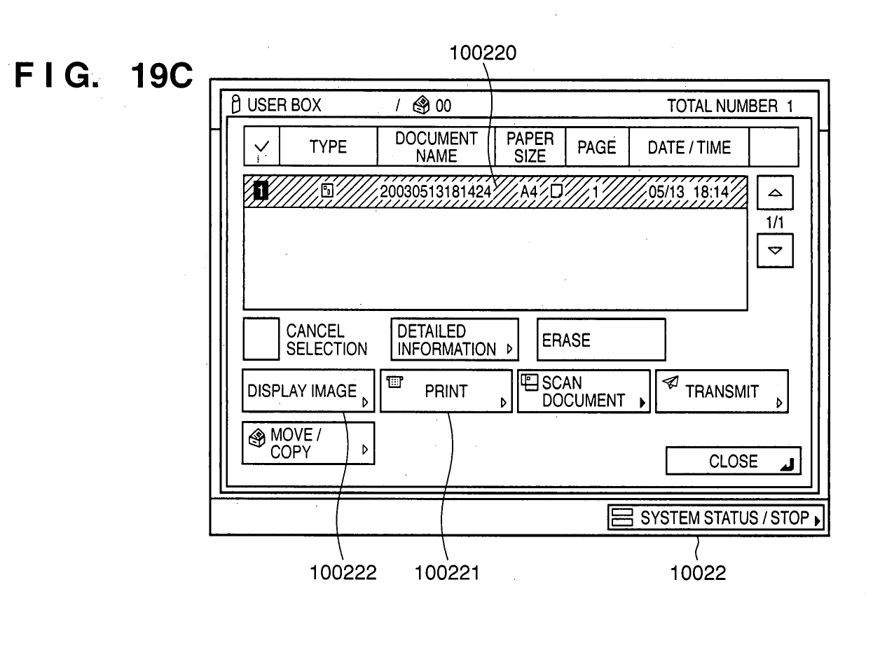

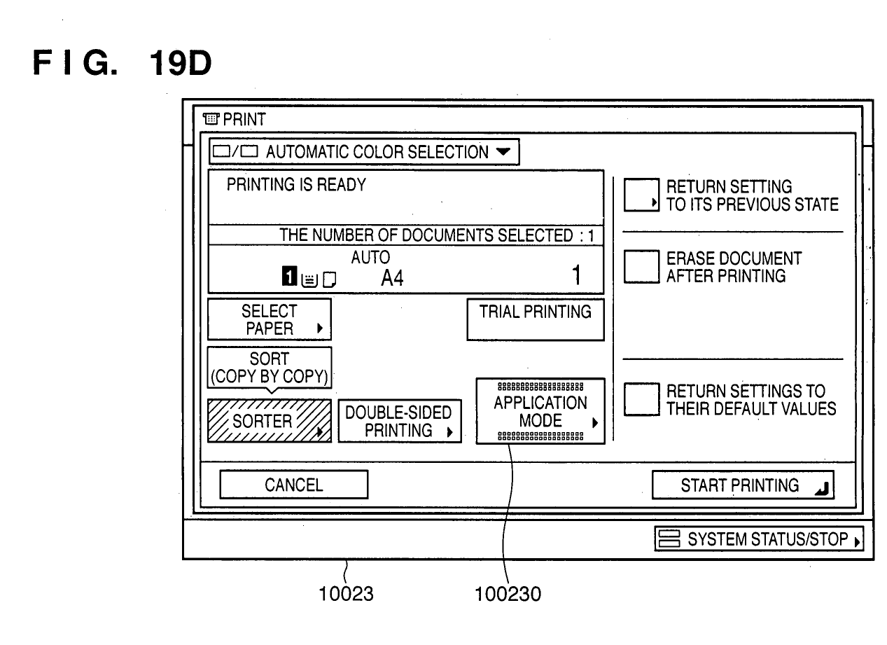

An operation window for saving image data read by the MFP 100 in the internal storage unit 111 (box function) will be described with reference to FIGS. 19A to 19D.

FIGS. 19A to 19D are views showing examples of operation windows according to the second embodiment of the present invention.

An operation window 10020 in FIG. 19A is a basic window for saving image data (box function). When a box key 100200 indicating Box 00 is touched out of a group of boxes (storage units) currently managed by the MFP 100, an operation window 10021 in FIG. 19B is displayed.

When a document scanning key 100211 is touched in the operation window 10021, a document scanning setting window is displayed. The document scanning setting window is similar to that in the transmission/FAX operation specification. The operation window 10012 in FIG. 18C is displayed.

This example shows a state wherein one data file has already been stored in Box 00. When a line 100210 for the data file is touched, the data file can be selected and processed.

An operation window 10022 in FIG. 19C shows a display state wherein the data file is selected. In this case, a selected line 100220 is highlighted (hatched). When the data file is selected, the contents of the data file can be confirmed. When an image display key 100222 is touched in this state, the operation window 10003 in FIG. 16 is displayed.

When a print key 100221 is touched in the operation window 10022 in FIG. 19C, an operation window 10023 in FIG. 19D is displayed to enable print setting. When an application mode key 100230 is touched in this state, the window 10001 in FIG. 4B is displayed.

As described above, according to the second embodiment, the states of an image before and after the skew correction process can be displayed to prompt the user to finally confirm whether to execute the skew correction process, in addition to the effects described in the first embodiment.

In this way, the user can be given a chance to confirm the state of the skew correction process, and execution of a skew correction process against the user's intension can be prevented.

### Third Embodiment

In the first embodiment, vector data is automatically generated including skew correction. In the second embodiment, a read image before the skew correction process is previewed after image reading, and the status of the skew correction process can be confirmed in advance in accordance with an operation.

In the first and second embodiments, objects of all attributes in a document image are subjected to the skew correction process. However, targets for the skew correction process may be restricted to only objects of a predetermined attribute depending on the application purpose.

In general, if an object such as a character, line, or table is skewed, the skew particularly stands out. A JPEG-compressed photo object requires a complicated, large-scale circuit or a long process time in order to implement a rotation process executed in the skew correction process. Further, even if a photo object skews slightly, the skew is not conspicuous or is negligible depending on the data contents.

From this, the third embodiment executes the skew correction process for only objects of a predetermined attribute (e.g., table). Since a table object is not obliquely laid out in general use, targets for the skew correction process are set to only table objects in a document image in the arrangement of the first or second embodiment and the skew correction process is then executed.

Alternatively, in the arrangement of the second embodiment, table objects undergo the skew correction process in advance, and an image formed from the result of the skew correction process and objects of other attributes that have not undergone the skew correction process may be previewed.

As described above, according to the third embodiment, whether to execute the skew correction process can be finally controlled for each object in an image, in addition to the effects described in the first and second embodiments.

In this manner, a skew correction process preferable for objects of different attributes can be executed in accordance with the application purpose.

### Fourth Embodiment

In the first to third embodiments, the skew correction process is executed for objects in a read image. Depending on the state of the convey system of an apparatus in printing, a printing paper sheet may be skewed, and an image may be skewed and printed on the printing paper sheet. To prevent this, the fourth embodiment applies the skew correction process to objects in vector data to be printed, and even when a printing paper sheet is skewed, an image can be printed at an accurate position.

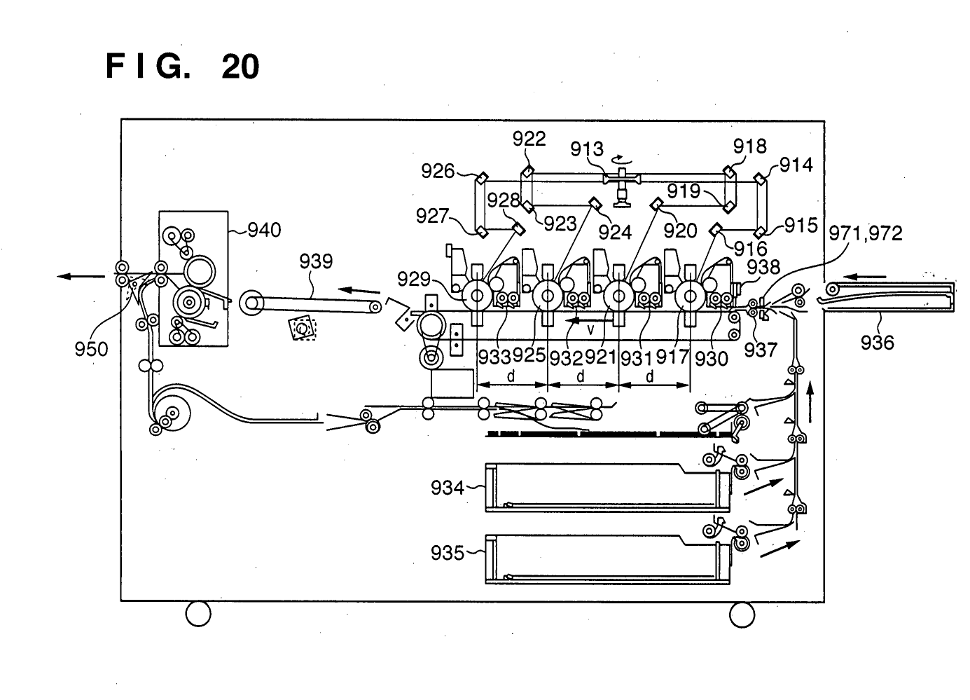

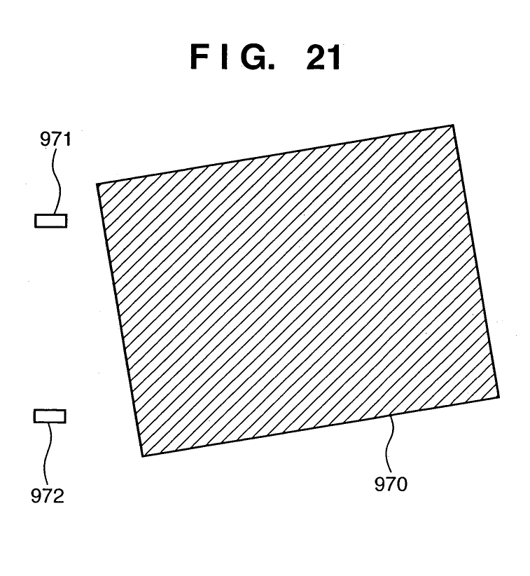

An example of arrangement of a printing unit 112 will be explained with reference to FIG. 20.

FIG. 20 is a sectional view showing an example of the arrangement of the printing unit according to the fourth embodiment of the present invention.

FIG. 20 illustrates a 4-drum type laser beam printer as an example of the printing unit 112.

In FIG. 20, reference numeral 913 denotes a polygon mirror which is irradiated with four laser beams emitted by four semiconductor laser oscillators (not shown). One of these four laser beams scans a photosensitive drum 917 via mirrors 914, 915, and 916. The next laser beam scans a photosensitive drum 921 via mirrors 918, 919, and 920. The third laser beam scans a photosensitive drum 925 via mirrors 922, 923, and 924. The final laser beam scans a photosensitive drum 929 via mirrors 926, 927, and 928.

Reference numeral 930 denotes a developing unit which supplies yellow (Y) toner and forms a yellow toner image on the photosensitive drum 917 in accordance with the laser beam. Reference numeral 931 denotes a developing unit which supplies magenta (M) toner and forms a magenta toner image on the photosensitive drum 921 in accordance with the laser beam. Reference numeral 932 denotes a developing unit which supplies cyan (C) toner and forms a cyan toner image on the photosensitive drum 925 in accordance with the laser beam. Reference numeral 933 denotes a developing unit which supplies black (K) toner and forms a black toner image on the photosensitive drum 929 in accordance with the laser beam. Toner images of the four colors (Y, M, C, and K) are transferred onto a printing paper sheet, obtaining a full-color output image.

A printing paper sheet supplied from one of sheet cassettes 934 and 935 and a manual feed tray 936 is chucked onto a transfer belt 938 via a registration roller 937 and conveyed. Toners of the respective colors are developed in advance on the photosensitive drums 917, 921, 925, and 929 in synchronism with the paper feed timing, and sequentially transferred onto the printing paper sheet as the printing paper sheet is conveyed.

The printing paper sheet bearing the toners of the respective colors is separated and conveyed by a convey belt 939, and the toners are fixed onto the printing paper sheet by a fixing unit 940. The printing paper sheet having passed through the fixing unit 940 is temporarily guided downward by a flapper 950, and after the trailing end of the printing paper sheet passes through the flapper 950, switched back and discharged. As a result, the printing paper sheet is faced down and discharged, and printouts are arranged in a correct order upon sequentially printing from the first page.

The four photosensitive drums 917, 921, 925, and 929 are arranged at equal intervals at a distance d. A printing paper sheet is conveyed by the convey belt 939 at a predetermined speed v, and the four semiconductor laser oscillators are driven in synchronism with the timing.

Photosensors 971 and 972 which detect the skew state (skew) of a printing paper sheet with respect to the convey direction are arranged on the printing paper convey path on the downstream side of the registration roller 937. The skew state of a printing paper sheet can be detected from the detection results of the photosensors 971 and 972.

A detection principle of detecting the skew state (skew) of a printing paper sheet will be explained with reference to FIG. 21.

FIG. 21 is a view for explaining the detection principle of detecting the skew state (skew) of a printing paper sheet according to the fourth embodiment of the present invention.

FIG. 21 illustrates a layout when the photosensors 971 and 972 of the printing unit 112 in FIG. 20 are viewed from the top. The photosensors 971 and 972 are laid out midway along the convey path before a printing paper sheet 970 reaches the position of the photosensitive drum 917.

If the printing paper sheet 970 is conveyed with a skew along the convey path, timings at which the photosensors 971 and 972 detect the printing paper sheet become different. This difference between the detection timings of the photosensors is calculated. Since the distance between the photosensors 971 and 972 and the printing paper convey speed v are known, the skew state (skew angle) of the printing paper sheet 970 with respect to the convey direction can be calculated from the known values and detection timing difference.

This calculation is executed by, e.g., a data processing unit 115.

The fourth embodiment executes a printing process including the skew correction process for vector data to be printed so as to print an image at an accurate position even when a printing paper sheet skews.

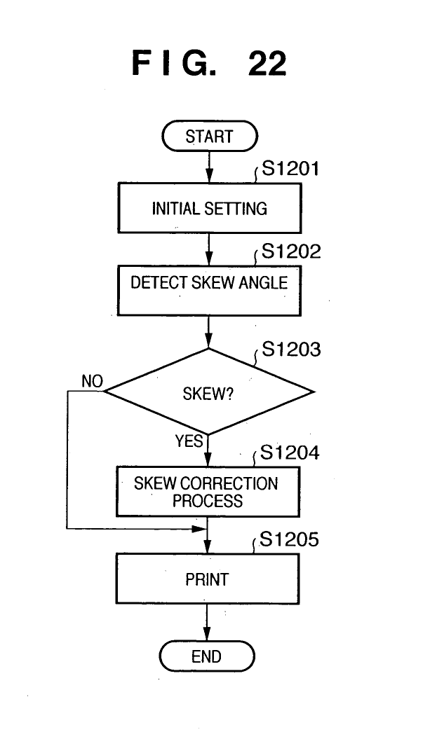

This skew correction process will be explained with reference to FIG. 22.

FIG. 22 is a flowchart showing the printing process according to the fourth embodiment of the present invention.

In step S1201, print settings such as paper selection and the number of prints are made as initial settings. The print settings are made via, e.g., an operation window 10023 in FIG. 19D. After printing is designated (printing starts), a printing paper sheet is fed from a designated sheet cassette (934, 935, or 936), conveyed to the position of the registration roller 937 via the photosensors 971 and 972, and temporarily stopped.

In step S1202, the skew angle of the printing paper sheet is calculated on the basis of the detection results of the photosensors 971 and 972. In step S1203, it is determined whether the printing paper sheet is skewed. If the printing paper sheet is not skewed (NO in step S1203), the process advances to step S1205 to execute printing based on vector data to be printed. If the printing paper sheet is skewed (YES in step S1203), the process advances to step S1204.

The skew is ideally determined to occur when a calculated skew angle is not 0°. However, some calculation error may be taken into consideration, and the skew is determined to occur when a calculated skew angle is equal to or larger than a predetermined angle (e.g., 2°).

In step S1204, a skew correction process of rotating vector data to be printed in a direction opposite to the skew direction is executed on the basis of the detected skew angle. When vector data to be printed contains vector data of a plurality of pages, the skew correction process is executed for vector data of each page. After that, in step S1205, printing is done on the basis of the vector data having undergone the skew correction process.

As described above, vector data can be easily rotated, and the skew correction process in printing can also be easily executed similar to the skew correction process in vector scan according to the first to third embodiments.

When printing is done subsequently to vector scan, a skew correction process in vector scan and that in printing can also be simultaneously performed. At this time, a skew correction angle in scan and that in printing are synthesized, and only one skew correction process (rotation process) suffices to be executed for skews generated in scan and printing.

When an increase in the speed of the printing process is expected, a skew angle may be detected in step S1202 without stopping conveyance of a printing paper sheet. In this case, for a lack of time, a skew correction process based on a detection result may not be executed for vector data to be printed on the first printing paper sheet depending on the performance of the data processing unit 115. In this arrangement, therefore, vector data having undergone the skew correction process are printed on the second and subsequent printing paper sheets, whereas vector data not having undergone the skew correction process is printed on the first printing paper sheet.

As described above, according to the fourth embodiment, even if a printing paper sheet is skewed in printing, the skew correction process is executed for vector data to be printed in accordance with the skew state, thereby printing an image at an accurate position on the printing paper sheet.

The first to fourth embodiments adopt an arrangement which performs the skew correction process regardless of the skew angle. Alternatively, an object which is skewed at a preset angle (e.g., 20°) or more may be regarded as an object which is laid out intentionally obliquely (skewed), and execution of the skew correction process for the object may be inhibited.

It can also be controlled whether to execute the skew correction process by referring to layout information of a predetermined vector data file. Further, it can also be controlled whether to execute the skew correction process by searching the feature of an image in scan and referring to the layout or skew angle of the original file data of the image that is separately saved in the server.

According to the first to fourth embodiments, the MFP 100 in FIG. 1 incorporates the vectorized process function (including the skew correction process) of converting input raster image data into a vector data file, and various operations are executed via the input unit 113 and display unit 116 of the MFP 100. However, the present invention is not limited to this.

For example, a management PC capable of controlling the MFP 100 may be configured, various operations may be done via the operation unit of the management PC, and raster image data input to the MFP 100 may be transferred to the management PC to execute various processes such as the vectorized process in the management PC.

In the first to third embodiments, the process in FIG. 3 is executed for an image read from the MFP 100 as an image to be processed. The process in FIG. 3 can also be executed for, e.g., printing data received from the client PC 102 or image data (e.g., image data captured by a digital camera) received via the network 104.

The first to third embodiment are implemented in the office 10 of FIG. 1, but may be implemented by an MFP in another office on the network 104 or an MFP on the network 104.

The image processing system is implemented by an MFP and management PC, but may be implemented by another device (e.g., digital camera or portable terminal (PDA, cell phone, or the like)) as far as the device can handle image data.

When an original image corresponding to input image data has already been managed in the storage unit of the MFP 100 or by a server on the network, the process in FIG. 3 may be executed for the original image.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-167672 filed on Jun. 4, 2004, the entire contents of which are hereby incorporated by reference herein.

1. An image processing apparatus which performs an image process for input image data, comprising:
input means for inputting image data;
division means for dividing the image data input from said input means into a plurality of blocks;
detection means for detecting a skew angle of each block divided by said division means;
convert means for converting the image data input from said input means into vector data for each block divided by said division means; and
correction means for correcting the vector data corresponding to the block on the basis of the skew angle of each block detected by said detection means.

2. The apparatus according to claim 1, wherein said input means includes reading means for reading a document.

3. The apparatus according to claim 1, wherein when a first block whose skew angle is corrected overlaps a second block, said correction means further corrects the vector data corresponding to at least one of the first block and the second block so that the vector data whose skew angle is corrected may not overlap each other.

4. The apparatus according to claim 3, wherein said correction means enlarges or reduces the vector data corresponding to at least one of the first block and the second block.

5. The apparatus according to claim 3, wherein said correction means changes a position of at least one of the first block and the second block.

6. The apparatus according to claim 1, wherein
said detection means detects a skew angle of a block of a predetermined attribute among the blocks divided by said division means, and
said correction means corrects the vector data corresponding to the block of the predetermined attribute on the basis of the skew angle detected by said detection means.

7. The apparatus according to claim 1, further comprising inhibit means for inhibiting execution of correction by said correction means when the skew angle detected by said detection means is not smaller than a predetermined angle.

8. An image processing apparatus which performs an image process for image data to be printed and outputs the image data to a printing unit, comprising:
first detection means for detecting a first skew angle, with respect to a convey direction, of a printing paper sheet conveyed along a printing paper convey path within the printing unit;
correction means for correcting vector data serving as the image data to be printed, on the basis of the first skew angle detected by said detection means; and
execution means for executing printing by the printing unit using the vector data corrected by said correction means.

9. The apparatus according to claim 8, further comprising:
input means for inputting image data;
division means for dividing the image data input from said input means into a plurality of blocks;
second detection means for detecting a second skew angle of each block divided by said division means; and
convert means for converting the image data input from said input means into vector data for each block divided by said division means,
wherein said correction means corrects the vector data converted by said convert means, on the basis of the first skew angle and the second skew angle which are detected by said first detection means and said second detection means.

10. A method of controlling an image processing apparatus which performs an image process for input image data, comprising:
an input step of inputting image data;
a division step of dividing the image data input in the input step into a plurality of blocks;
a detection step of detecting a skew angle of each block divided in the division step;
a convert step of converting the image data input in the input step into vector data for each block divided in the division step; and
a correction step of correcting the vector data corresponding to the block on the basis of the skew angle of each block detected in the detection step.

11. The method according to claim 10, wherein in the correction step, when a first block whose skew angle is corrected overlaps a second block, the vector data corresponding to at least one of the first block and the second block is further corrected so that the vector data whose skew angle is corrected may not overlap each other.

12. The method according to claim 11, wherein in the correction step, the vector data corresponding to at least one of the first block and the second block is enlarged or reduced.

13. The method according to claim 11, wherein in the correction step, a position of at least one of the first block and the second block is changed.

14. A method of controlling an image processing apparatus which performs an image process for image data to be printed and outputs the image data to a printing unit, comprising:
a first detection step of detecting a first skew angle, with respect to a convey direction, of a printing paper sheet conveyed along a printing paper convey path within the printing unit;
a correction step of correcting vector data serving as the image data to be printed, on the basis of the first skew angle detected in the detection step; and
an execution step of executing printing by the printing unit using the vector data corrected in the correction step.

15. A program for implementing control of an image processing apparatus which performs an image process for input image data, comprising:
a program code for an input step of inputting image data;
a program code for a division step of dividing the image data input in the input step into a plurality of blocks;
a program code for a detection step of detecting a skew angle of each block divided in the division step;
a program code for a convert step of converting the image data input in the input step into vector data for each block divided in the division step; and
a program code for a correction step of correcting the vector data corresponding to the block on the basis of the skew angle of each block detected in the detection step.

16. The program according to claim 15, wherein in the correction step, when a first block whose skew angle is corrected overlaps a second block, the vector data corresponding to at least one of the first block and the second block is further corrected so that the vector data whose skew angle is corrected may not overlap each other.

17. The program according to claim 16, wherein in the correction step, the vector data corresponding to at least one of the first block and the second block is enlarged or reduced.

18. The program according to claim 16, wherein in the correction step, a position of at least one of the first block and the second block is changed.

19. A program for implementing control of an image processing apparatus which performs an image process for image data to be printed and outputs the image data to a printing unit, comprising:
a program code for a first detection step of detecting a first skew angle, with respect to a convey direction, of a printing paper sheet conveyed along a printing paper convey path within the printing unit;
a program code for a correction step of correcting vector data serving as the image data to be printed, on the basis of the first skew angle detected in the detection step; and
a program code for an execution step of executing printing by the printing unit using the vector data corrected in the correction step.
